(19) United States
(12) Patent Application Publication
(10) Pub. No.: US 2026/0343329 A1
(43) Pub. Date: Oct. 29, 2026

(54) Mobility Management Method and Device

(71) Applicant: CHINA SATELLITE NETWORK INNOVATION CO., LTD, Beijing (CN)

(72) Inventors: Rui TENG, Beijing (CN); Yingying WANG, Beijing (CN); Chunlei NIU, Beijing (CN); Ying ZHAO, Beijing (CN)

(73) Assignee: CHINA SATELLITE NETWORK INNOVATION CO., LTD, Beijing (CN)

(21) Appl. No.: 19/565,164

(22) Filed: Mar. 12, 2026

Related U.S. Application Data
(63) Continuation of application No. PCT/CN2025/129757, filed on Oct. 24, 2025.

(30) Foreign Application Priority Data
Apr. 24, 2025 (CN) 202510526871.5

(51) Int. Cl. H04W 36/00; H04W 36/18; H04W 84/06; H04W 92/20

(52) U.S. Cl. CPC H04W 36/0016; H04W 36/18; H04W 84/06; H04W 92/20

(57) ABSTRACT

System and methods of a mobility management method is provided. The mobility management method includes: determining a Transport Network Layer (TNL) link of an Non-Terrestrial Network (NTN) device; and sending indication information to a core network device, where the indication information can indicate a handover configuration of the TNL link.

### CROSS REFERENCE TO RELATED APPLICATIONS

This application is a continuation of International Application No. PCT/CN2025/129757 filed on Oct. 24, 2025, under U.S.C. § 111(a), which is based on and claims priority to Chinese Patent Application No. 202510526871.5 filed on Apr. 24, 2025 and entitled “Mobility Management Method and Device”, both of which are incorporated herein by reference in their entirety for all purposes.

### FIELD

The present disclosure relates to the technical field of communications, and in particular, to a mobility management method and a device.

### BACKGROUND

Non-Terrestrial Networks (NTN) have the characteristics of extensive coverage areas, flexible networking, etc., and may provide ubiquitous coverage capabilities without being constrained by topography and landforms. During the movement of an NTN network device, a connection between the device and a ground gateway continuously changes, resulting in numerous and frequent signaling interaction at an NG interface between a core network and an access network, which is prone to causing a signaling storm and is unfavorable to mobility management at the NG interface. Furthermore, the communication between the NTN network device and the core network device is performed wirelessly, and a long distance leads to a large transmission delay. This increases the likelihood of the occurrence of the signaling storm to a greater extent.

### SUMMARY

Embodiments of the present specification provide a mobility management method and a device, so as to reduce the number of signaling interactions on an NG interface.

According to a first aspect of an embodiment of the present specification, a mobility management method is provided. The method is applied to an NTN network device and includes the following operations. Determining a Transport Network Layer (TNL) link of the NTN network device; And sending indication information to a core network device, wherein the indication information is configured to indicate a handover configuration of the TNL link.

According to a second aspect of an embodiment of the present specification, a mobility management method is provided. The method is applied to a core network device and includes the following operations. Receiving indication information sent by a Non-Terrestrial Network (NTN) network device, wherein the indication information is configured to indicate a handover configuration of a Transport Network Layer (TNL) link of the NTN network device; And updating an available state of the TNL link based on the indication information.

According to a third aspect of an embodiment of the present specification, a mobility management method is provided. The method is applied to a first NTN network device and includes the following operations. Determining a Transport Network Layer (TNL) link of the first NTN network device; And sending indication information to a second NTN network device, wherein the indication information is configured to indicate a handover configuration of the TNL link.

According to a fourth aspect of an embodiment of the present specification, a mobility management method is provided. The method is applied to a second NTN network device and includes the following operations. Receiving indication information sent by a first NTN network device, wherein the indication information is configured to indicate a handover configuration of a Transport Network Layer (TNL) link; And determining an available state of the TNL link based on the indication information.

According to a fifth aspect of an embodiment of the present specification, an NTN network device is provided. The NTN network device includes a processor and a memory. The memory is configured to store a computer program executable on the processor, and the processor, when executing the computer program, implements instructions of the method in the first aspect, third aspect, or fourth aspect.

According to a sixth aspect of an embodiment of the present specification, a core network device is provided. The core network device includes a processor and a memory. The memory is configured to store a computer program executable on the processor, and the processor, when executing the computer program, implements instructions of the method in the second aspect.

### BRIEF DESCRIPTION OF THE DRAWINGS

To describe the technical solutions in embodiments of the present specification or the related art more clearly, the following briefly describes the accompanying drawings required for describing the embodiments or the related art. The accompanying drawings in the following description merely show some embodiments described in the present specification, and those of ordinary skill in the art may still derive other drawings from these accompanying drawings without creative efforts.

FIG. 1 is a schematic diagram of feeder link handover according to an embodiment of the present specification.

FIG. 2 is a schematic diagram of a soft handover process in the related art.

FIG. 3 is a schematic diagram of a hard handover process in the related art.

FIG. 4 is a schematic flowchart of a mobility management method according to an embodiment of the present specification.

FIG. 5 is a schematic flowchart of a mobility management method according to an embodiment of the present specification.

FIG. 6 is a schematic diagram of a soft handover process according to an embodiment of the present specification.

FIG. 7 is a schematic diagram of a hard handover process according to an embodiment of the present specification.

FIG. 8 is a schematic diagram of a process of establishing a connection between an NTN network device and a core network device according to an embodiment of the present specification.

FIG. 9 is a schematic flowchart of a mobility management method according to an embodiment of the present specification.

FIG. 10 is a schematic flowchart of a mobility management method according to an embodiment of the present specification.

FIG. 11 is a schematic flowchart of a mobility management method according to an embodiment of the present specification.

FIG. 12a is a schematic diagram of an interaction process among a first NTN network device, a second NTN network device, and a core network device according to an embodiment of the present specification.

FIG. 12b is a schematic diagram of an interaction process among a first NTN network device, a second NTN network device, and a core network device according to an embodiment of the present specification.

FIG. 13 is a schematic diagram of an interaction process among a first NTN network device, a second NTN network device, and a core network device according to an embodiment of the present specification.

FIG. 14 is a schematic flowchart of a mobility management method according to an embodiment of the present specification.

FIG. 15 is a schematic structural diagram of a mobility management apparatus according to an embodiment of the present specification.

FIG. 16 is a schematic structural diagram of a mobility management apparatus according to an embodiment of the present specification.

FIG. 17 is a schematic structural diagram of a mobility management apparatus according to an embodiment of the present specification.

FIG. 18 is a schematic structural diagram of a mobility management apparatus according to an embodiment of the present specification.

### DETAILED DESCRIPTION OF THE EMBODIMENTS

The technical solutions in the embodiments of the present specification will be clearly and completely described below in combination with the drawings in the embodiments of this specification. It is apparent that the described embodiments are merely part of the embodiments of this specification, not all the embodiments. The specific embodiments described here are merely used for explaining the present disclosure rather than limiting the present disclosure. On the basis of the described embodiments in the present disclosure, all other embodiments obtained by those of ordinary skill in the art shall fall within the protection scope of the present disclosure. Furthermore, relational terms such as “first” and “second” are used merely to distinguish one entity or operation from another entity or operation herein, and do not necessarily require or imply the existence of any such actual relationship or order between these entities or operations.

An NG interface is an interface between a network device and a core network device. The NG interface may include an NG-C interface and an NG-U interface. The NG-C interface is an interface between the network device and an access and mobility management function (AMF) entity in the core network device. The NG-U interface is an interface between the network device and a user plane function (UPF) entity in the core network device. In Terrestrial Networks (TN), a position of a TN device is fixed. Signaling over the NG interface is transmitted in a wired manner, ensuring delays and reliability. Whether it involves the creation of an NG interface, the deletion of the NG interface, or the updating of RAN configuration, frequent signaling interactions typically do not cause delays or reliability problems. However, in an NTN, the NTN network device and the core network device are no longer connected in a wired manner, but in a wireless manner, and a long distance leads to a large transmission delay. The movement of the NTN network device leads to numerous and frequent signaling interactions at the NG interface, potentially triggering a signaling storm, which is unfavorable to mobility management at the NG interface.

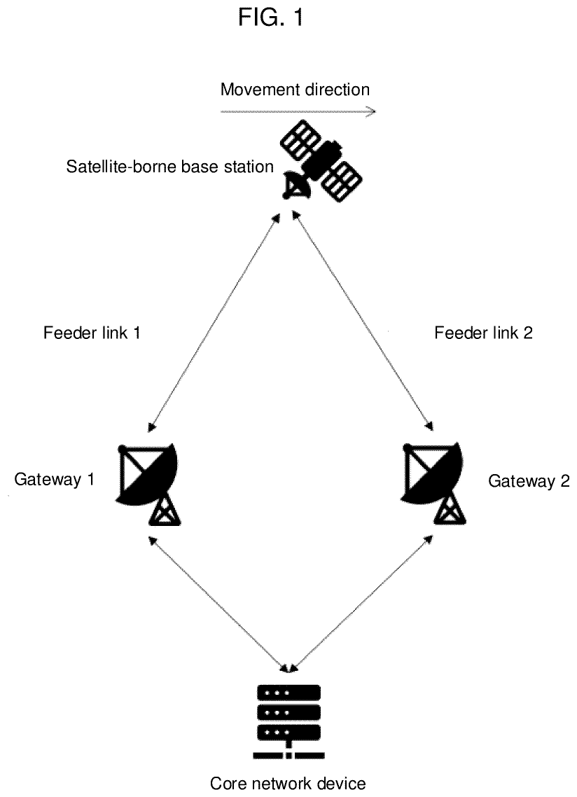

For example, the NTN network device is a satellite-borne Base Station (BS). The satellite-borne BS is a BS that is deployed on a satellite device. The satellite-borne BS may communicate with the core network device via a gateway. During the movement of the satellite-borne BS, a connection between the satellite-borne BS and the gateway changes, Feeder Link Switch Over (namely, Feeder Link Handover) occurs. A feeder link is a physical link between the satellite-borne BS and the gateway. The type of Feeder Link Switch Over includes soft handover and hard handover. For soft handover, during handover, a connection between a new feeder link and an old feeder link can be maintained at the same time, and then the old feeder link is disconnected at the appropriate time. For hard handover, during handover, the old feeder link may be disconnected, and the new feeder link is connected. The disconnection of the old feeder link and the connection of the new feeder link may be performed at the same time or may be performed with a short interval preset time. For example, the old feeder link may be disconnected first, and then the new feeder link is connected within the set time. For another example, the new feeder link may be connected first, and then the old feeder link is disconnected within the set time. For another example, the connection of the new feeder link and the disconnection of the old feeder link may be performed at the same time. The new feeder link is a feeder link newly added between the satellite-borne BS and the gateway. The old feeder link is an existing feeder link between the satellite-borne BS and the gateway. Referring to FIG. 1, the satellite-borne BS may be connected to a gateway 1, such that the core network device may be connected via a feeder link 1. The feeder link 1 is a physical link between the satellite-borne BS and the gateway 1. The feeder link 1 may be understood as the old feeder link. Due to the movement of the satellite-borne BS, the satellite-borne BS may be connected to a gateway 2, such that the core network device may be connected via a feeder link 2. The feeder link 2 is a physical link between the satellite-borne BS and the gateway 2. The feeder link 2 may be understood as the new feeder link.

One feeder link may support one or more TNL links. The TNL link is a logical link or physical link between the satellite-borne BS and the core network device, and is configured to implement data transmission between the satellite-borne BS and the core network device. With continued reference to FIG. 1, the feeder link 1 supports a TNL link 1. The feeder link 2 supports a TNL link 2. Due to the movement of the satellite-borne BS, a handover from the feeder link 1 to the feeder link 2 occurs, and a handover from the TNL link 1 to the TNL link 2 also occurs accordingly. Through the handover of the TNL links, an NGAP connection between the satellite-borne BS and the core network device can be maintained at a Radio Network Layer (RNL), but a path of the TNL changes.

Corresponding to the handover type of the feeder link, the handover type of the TNL links may include soft handover and hard handover.

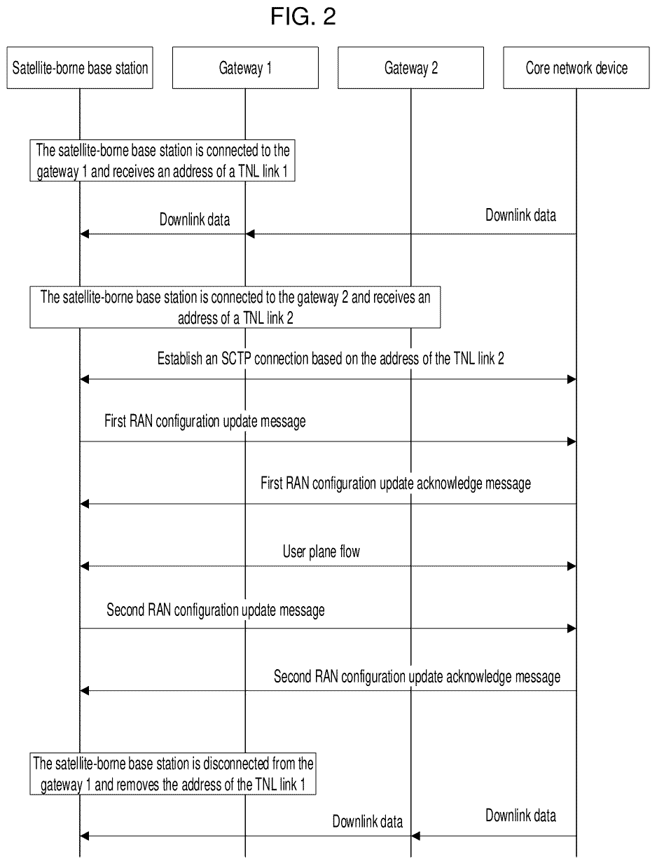

In the related art, a soft handover process is shown in FIG. 2. The satellite-borne BS is connected to the gateway 1. The physical link between the satellite-borne BS and the gateway 1 is the feeder link 1. The feeder link 1 supports a TNL link 1. The gateway 1 is configured with an address of the TNL link 1 in advance. The satellite-borne BS may acquire the address of the TNL link 1 via the gateway 1; and a Stream Control Transmission Protocol (SCTP) connection may be established based on the address of the TNL link 1. The core network device may use the TNL link 1 to send downlink data to the satellite-borne BS. For example, the core network device may send the downlink data to the gateway 1, and the gateway 1 receives the downlink data and sends same to the satellite-borne BS. The satellite-borne BS may use the TNL link 1 to send uplink data to the core network device. For example, the satellite-borne BS may send the uplink data to the gateway 1, and the gateway 1 receives the uplink data and sends it to the core network device.

Due to the movement of the satellite-borne BS, the satellite-borne BS is connected to the gateway 2. The physical link between the satellite-borne BS and the gateway 2 is the feeder link 2. The feeder link 2 supports a TNL link 2. The gateway 2 is configured with an address of the TNL link 2 in advance. The satellite-borne BS acquires the address of the TNL link 2 via the gateway 2, and may establish an SCTP connection based on the address of the TNL link 2. The handover type of the TNL link 2 is soft handover. In this case, the satellite-borne BS simultaneously maintains the SCTP connection corresponding to the TNL link 1 and the SCTP connection corresponding to the TNL link 2. Based on the TNL link 1 and the TNL link 2, the satellite-borne BS may send the uplink data by using a plurality of different paths.

The satellite-borne BS may send a first Radio Access Network (RAN) configuration update message to the core network device. The first RAN configuration update message is configured to indicate that the core network device may be connected to the satellite-borne BS via the TNL link 2. The core network device may add the TNL link 2 to the NG interface according to the first RAN configuration update message, thereby updating the configuration of the NG interface. The NG interface is an interface between the satellite-borne BS and the core network device. The core network device may send a first RAN configuration update acknowledge message to the satellite-borne BS. In this case, the core network device simultaneously maintains the SCTP connection corresponding to the TNL link 1 and the SCTP connection corresponding to the TNL link 2. Based on the TNL link 1 and the TNL link 2, the core network device may send the downlink data by using a plurality of different paths.

The satellite-borne BS and the core network device may perform Protocol Data Unit (PDU) session modification for a User Equipment (UE) of a current serving cell, so as to prepare for user plane data transmission.

When the satellite-borne BS is disconnected from the gateway 1 due to movement, the TNL link 1 is unavailable. The satellite-borne BS may send a second RAN configuration update message to the core network device. The second RAN configuration update message is configured to indicate that the core network device cannot be connected to the satellite-borne BS via the TNL link 1. The core network device may remove the TNL link 1 from the NG interface according to the second RAN configuration update message, so as to stop sending data to the gateway 1. The core network device may send a second RAN configuration update acknowledge message to the satellite-borne BS. An Information Element (IE) in the second RAN configuration update message may be shown in Table 1 below.

TABLE 1

| | | | IE type | | | Criticality |
|---|---|---|---|---|---|---|
| IE/Group | | | and | Semantic | | of |
| name | Exist | Range | reference | description | Criticality | allocation |
| NG-RAN | | 0 . . . 1 | | | Yes | Refuse |
| TNL | | | | | | |
| Association | | | | | | |
| Delete list | | | | | | |
| NG-RAN | | 1 . . . | | | | |
| TNL | | <maxnoofTNLAssociations> | | | | |
| Association | | | | | | |
| Delete item | | | | | | |
| TNL | M | | CP Transport | Transport | | |
| Association | | | Layer | layer | | |
| Transport | | | Information | address for | | |
| layer | | | 9.3.2.6 | NG-RAN | | |
| address | | | | node | | |
| TNL | O | | CP Transport | AMF | | |
| Association | | | Layer | service | | |
| AMF | | | Information | address of | | |
| service | | | 9.3.2.6 | transport | | |
| address | | | | layer | | |

In this case, the core network device maintains the SCTP connection corresponding to the TNL link 2, and does not maintain the SCTP connection corresponding to the TNL link 1. The core network device may send the downlink data to the gateway 2, and the gateway 2 may receive the downlink data and sends it to the satellite-borne BS.

In the above soft handover process, the first RAN configuration update message is configured to instruct the core network device to add the TNL link 2 to the NG interface, and the second RAN configuration update message is configured to instruct the core network device to remove the TNL link 1 from the NG interface. After receiving the first RAN configuration update message, the core network device may send the downlink data to the gateway 1 and/or gateway 2, and stops sending the data to the gateway 2 until receiving the second RAN configuration update message. Therefore, in addition to including the first RAN configuration update message and the first RAN configuration update acknowledge message, the signaling interaction between the satellite-borne BS and the core network device also needs to include the second RAN configuration update message and the second RAN configuration update acknowledge message. There are numerous and frequent signaling interactions at the NG interface, potentially triggering a signaling storm, which unfavorable to the mobility management of the satellite-borne BS, and a service transmission delay may also be caused.

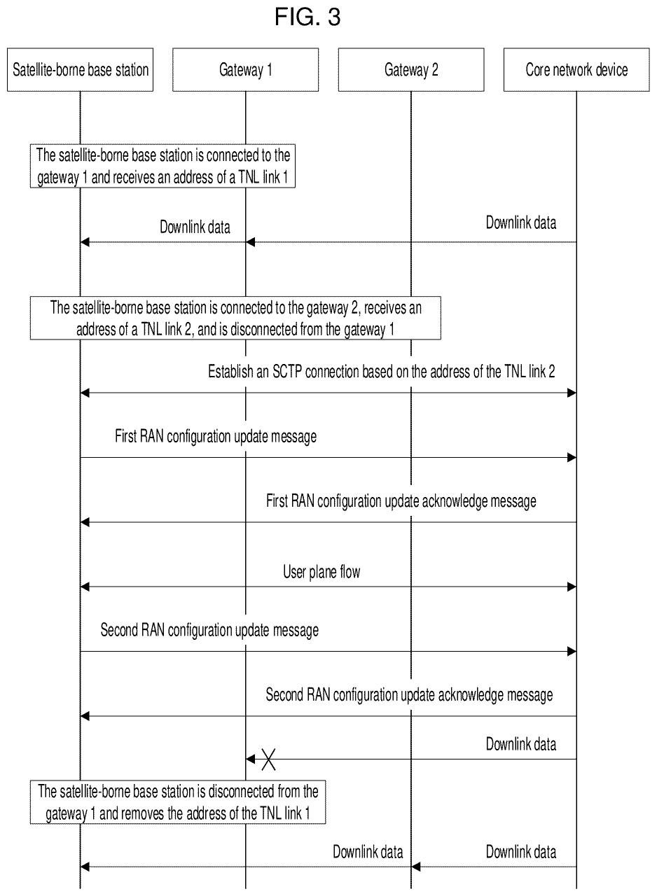

In the related art, a hard handover process is shown in FIG. 3. The satellite-borne BS is connected to the gateway 1. The physical link between the satellite-borne BS and the gateway 1 is the feeder link 1. The feeder link 1 supports a TNL link 1. The gateway 1 is configured with an address of the TNL link 1 in advance. The satellite-borne BS may acquire the address of the TNL link 1 via the gateway 1; and a Stream Control Transmission Protocol (SCTP) connection may be established based on the address of the TNL link 1. The core network device may use the TNL link 1 to send downlink data to the satellite-borne BS. For example, the core network device may send the downlink data to the gateway 1, and the gateway 1 may receive the downlink data and sends it to the satellite-borne BS. The satellite-borne BS may use the TNL link 1 to send uplink data to the core network device. For example, the satellite-borne BS may send the uplink data to the gateway 1, and the gateway 1 receives the uplink data and sends it to the core network device.

Due to the movement of the satellite-borne BS, the satellite-borne BS is connected to the gateway 2. The physical link between the satellite-borne BS and the gateway 2 is the feeder link 2. The feeder link 2 supports a TNL link 2. The gateway 2 is configured with an address of the TNL link 2 in advance. The satellite-borne BS may acquire the address of the TNL link 2 via the gateway 2. The satellite-borne BS may establish an SCTP connection based on the address of the TNL link 2. The handover type of the TNL link 2 is hard handover. In this case, the satellite-borne BS may be disconnected from the gateway 1. The satellite-borne BS maintains the SCTP connection corresponding to the TNL link 2, and does not maintain the SCTP connection corresponding to the TNL link 1.

The satellite-borne BS may send a first RAN configuration update message to the core network device. The first RAN configuration update message is configured to indicate that the core network device may be connected to the satellite-borne BS via the TNL link 2. The core network device may add the TNL link 2 to the NG interface according to the first RAN configuration update message, thereby updating the configuration of the NG interface. The core network device may send a first RAN configuration update acknowledge message to the satellite-borne BS. In this case, the core network device simultaneously maintains the SCTP connection corresponding to the TNL link 1 and the SCTP connection corresponding to the TNL link 2. The core network device may send the downlink data to the gateway 1 or gateway 2.

The satellite-borne BS and the core network device may perform Protocol Data Unit (PDU) session modification for a User Equipment (UE) of a current serving cell, so as to prepare for user plane data transmission.

The satellite-borne BS is disconnected from the gateway 1, and the TNL link 1 is unavailable, such that the satellite-borne BS also needs to send the second RAN configuration update message to the core network device. The second RAN configuration update message is configured to indicate that the core network device cannot be connected to the satellite-borne BS via the TNL link 1. The core network device may remove the TNL link 1 from the NG interface according to the second RAN configuration update message, so as to stop sending data to the gateway 1. The core network device may send a second RAN configuration update acknowledge message to the satellite-borne BS. The Information Element (IE) in the second RAN configuration update message may be shown in Table 1 below.

In this case, the core network device maintains the SCTP connection corresponding to the TNL link 2, and does not maintain the SCTP connection corresponding to the TNL link 1. The core network device may send the downlink data to the gateway 2, and the gateway 2 may receive the downlink data and sends it to the satellite-borne BS.

In the above hard handover process, the first RAN configuration update message is configured to instruct the core network device to add the TNL link 2 to the NG interface, and the second RAN configuration update message is configured to instruct the core network device to remove the TNL link 1 from the NG interface. After receiving the first RAN configuration update message, the core network device may send the downlink data to the gateway 1 and/or gateway 2, and stops sending the data to the gateway 2 until receiving the second RAN configuration update message. Therefore, in addition to including the first RAN configuration update message and the first RAN configuration update acknowledge message, the signaling interaction between the satellite-borne BS and the core network device also needs to include the second RAN configuration update message and the second RAN configuration update acknowledge message. There are numerous and frequent signaling interactions at the NG interface, potentially triggering a signaling storm, which is unfavorable to the mobility management of the satellite-borne BS, and a service transmission delay may also be caused.

Furthermore, within the time periods after the core network device receives the first RAN configuration update message and before receiving the second RAN configuration update message, the satellite-borne BS has been disconnected from the gateway 1. However, the core network device does not know that the satellite-borne BS has been disconnected from the gateway 1, and the TNL link 1 on the NG interface is not removed. Therefore, the core network device may send the downlink data to the gateway 1. If the core network device may send the downlink data to the gateway 1, the gateway 1 cannot send the downlink data to the satellite-borne BS after receiving the downlink data, leading to a downlink data transmission failure, thus affecting service continuity.

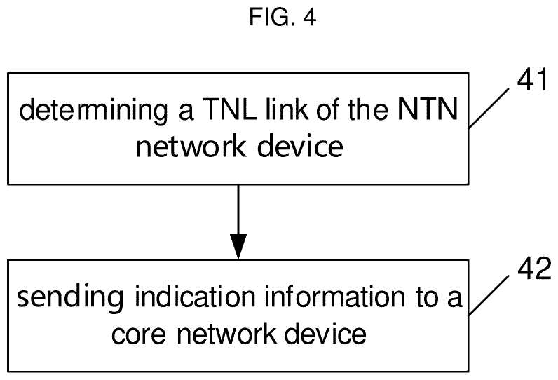

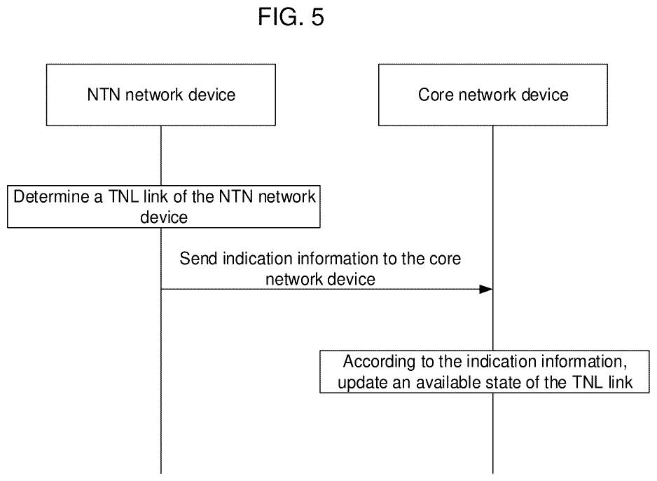

An embodiment of the present specification provides a mobility management method. The mobility management method may be applied to an NTN network device. Referring to FIGS. 4 and 5, the mobility management method may include the following steps.

At S41, determining a TNL link of the NTN network device.

At S42, sending indication information to a core network device.

The network device refers to a device that connects a terminal device to a communication network and provides a service to the terminal device. The network device includes, but is not limited to, the following devices: a BS, an Access Point (AP), a Transmission Reception Point (TRP), a broadcast transmitter, a Mobile Management Entity (MME), a gateway, a server, a Radio Network Controller (RNC), a Base Station Controller (BSC), etc. The BS includes, but is not limited to, a Node B (NB), an eNode B (eNB), a 5G BS (gNB), a 6G BS, a future BS, etc. Furthermore, a Remote Radio Head (RRH), a Remote Radio Unit (RRU), a relay, or a low-power node (e.g., femto, pico, etc.) may further be included. The NTN network device may include a network device (e.g., the satellite-borne BS) deployed on a satellite device, a network device deployed on a high altitude platform, an unmanned aerial vehicle network device, an aircraft network device, a communication balloon network device, etc. The satellite device includes a Highly Elliptical Orbiting (HEO) satellite, a GEO satellite, a Medium Earth Orbit (MEO) satellite, a Low Earth Orbit (LEO) satellite, etc.

The core network device may implement functions such as user access control, mobility management, session management, user security authentication, charging, etc. The core network device includes entities such as an access and mobility management function (AMF) unit, a session management function (SMF) unit, a user plane function (UPF) unit, a unified data management (UDM) unit, a policy and charging control (PCC) unit, etc. The entities in the core network device may be all deployed on the ground. Alternatively, one or more entities (e.g., the AMF) in the core network device may be deployed on a non-ground device (e.g., the satellite device).

The feeder link is a physical link between the NTN network device and the gateway. The gateway may also be referred to as a gateway station, a ground station, or an earth station, etc., and is configured to connect the NTN network device and the core network device. During the movement of the NTN network device, the connection between the NTN network device and the gateway changes, leading to Feeder Link Switch Over. One feeder link may support one or more TNL links. The TNL link is a logical link or physical link between the network device and the core network device, and is configured to implement data transmission between the network device and the core network device. Feeder Link Switch Over causes the handover of the TNL link supported by the feeder link accordingly.

The NTN network device may determine its own TNL link, and may send the indication information to the core network device. The indication information is configured to indicate the handover configuration of the TNL link. By indicating the handover configuration of the TNL link on the NTN network device side, the available state of the TNL link may be indicated, such that the core network device can automatically update the TNL link on the NG interface, thereby guaranteeing the connection of the NG interface during mobility management. Therefore, the number of signaling interactions of the NG interface (e.g., the NG-C interface) may be reduced, and a service transmission delay may also be reduced. For example, the NTN network device does not need to send the RAN configuration update message configured to add a new TNL link (e.g., the first TNL link) and the RAN configuration update message configured to remove an old TNL link (e.g., the second TNL link), respectively, such that the number of signaling interactions between the NTN network device and the core network device may be reduced.

In some embodiments, the type of Feeder Link Switch Over includes soft handover and hard handover. For soft handover, during handover, a connection between a new feeder link and an old feeder link can be maintained at the same time, and then the old feeder link is disconnected at the appropriate time. For hard handover, during handover, the old feeder link may be disconnected, and the new feeder link is connected. The disconnection of the old feeder link and the connection of the new feeder link may be performed at the same time or may be performed with a short interval preset time. For example, the old feeder link may be disconnected first, and then the new feeder link is connected within the set time. For another example, the new feeder link may be connected first, and then the old feeder link is disconnected within the set time. For another example, the connection of the new feeder link and the disconnection of the old feeder link may be performed at the same time.

Corresponding to the handover type of the feeder link, the handover type of the TNL links may include soft handover and hard handover. For soft handover, during handover, the connection between the new TNL link and the old TNL link can be maintained at the same time, and the NTN network device and the core network device may maintain a logical connection of the NG interface via one or more TNL links. For hard handover, during handover, the old TNL link may be disconnected, and the new TNL link is connected. The disconnection of the old TNL link and the connection of the new TNL link may be performed at the same time or may be performed with a short interval preset time. For example, the old TNL link may be disconnected first, and then the new TNL link is connected within the set time. For another example, the new TNL link may be connected first, and then the old TNL link is disconnected within the set time. For another example, the connection of the new TNL link and the disconnection of the old TNL link may be performed at the same time. For hard handover, during handover, the NTN network device and the core network device may maintain a logical connection of the NG interface via one TNL link.

The new feeder link is a feeder link newly added between the satellite-borne BS and the gateway. The new TNL link is a newly-added TNL link, which may, for example, be a TNL link supported by the new feeder link. The old feeder link is an existing feeder link between the satellite-borne BS and the gateway. The old TNL link is an existing TNL link, which may, for example, be a TNL link supported by the old feeder link.

In some embodiments of S41, due to the movement of the NTN network device, the connection between the NTN network device and the gateway changes, leading to Feeder Link Switch Over. The NTN network device may determine the TNL link during the occurring of Feeder Link Switch Over. For example, the NTN network device may determine the TNL link when connecting to a new gateway.

When Feeder Link Switch Over occurs, the NTN network device needs to send the RAN configuration update message to the core network device, so as to update the configuration of the core network device. Therefore, the indication information may be carried by the RAN configuration update message. In this way, the NTN network device may indicate the handover configuration of the TNL link by means of updating the configuration.

Alternatively, the NTN network device may determine the TNL link when required to establish a connection with the core network device. For example, the NTN network device may determine the TNL link when required to establish the connection with the core network device for the first time. Alternatively, the NTN network device may determine the TNL link in advance before establishing the connection with the core network device. The NTN network device may send an NG setup request message to the core network device when required to establish the connection with the core network device. Therefore, the indication information may be carried by an NG setup request message. In this way, the NTN network device may indicate the handover configuration of the TNL link by means of establishing a connection.

In some embodiments of S41, the NTN network device may determine one or more first TNL links. The first TNL link is a newly added TNL link between the core network device and the NTN network device. For example, the first TNL link may be a TNL link that has not established a communication connection, or may also be a TNL link that has established the communication connection but not been configured to implement data transmission.

As an example, the NTN network device may determine one or more first TNL links during the occurring of Feeder Link Switch Over. For example, the NTN network device may acquire the TNL link supported by the new feeder link as the first TNL link.

As another example, the NTN network device may determine one or more first TNL links when required to establish a connection with the core network device. Alternatively, the NTN network device may determine one or more first TNL links in advance before establishing the connection with the core network device. The first TNL link is a TNL link that may be established in the future during the movement of the NTN network device. The NTN network device may acquire the TNL link that may be established in the future as the first TNL link according to its own movement trajectory.

In an NTN, the NTN network device has high dynamicity. The movement characteristic of the NTN network device may be predictable. The connection between the NTN network device and the gateway may be predetermined. The NTN network device knows which gateway or gateways it is connected to. Furthermore, the gateway is connected to the core network device. The core network device knows the gateway it is connected to. Information such as an IP address, a position, etc. of the gateway does not change. The information of the gateway and the information of the core network device may be sent to the NTN network device in advance. For example, the information of the gateway and the information of the core network device may be sent to the NTN network device by means of Operation Administration and Maintenance (OAM) configuration or pre-configuration. The NTN network device may determine the TNL link that may be established in the future as the first TNL link according to one or more of its own movement trajectory, the information of the gateway, and the information of the core network device. The TNL link that may be established in the future may include a TNL link supported by the gateway to which the NTN network device may be connected in the future. For example, the NTN network device may include the satellite-borne BS. The satellite-borne BS determines the TNL link that may be established in the future as the first TNL link according to one or more of its own movement trajectory, ephemeris information, the information of the gateway, and the information of the core network device.

In some embodiments of S41, the NTN network device may determine one or more second TNL links. The second TNL link is an existing TNL link between the core network device and the NTN network device. The second TNL link has been configured to implement data transmission between the NTN network device and the core network device. By using the second TNL link, the core network device may send the downlink data to the NTN network device, and the NTN network device may send the uplink data to the core network device.

As an example, the NTN network device may determine one or more second TNL links during the occurring of Feeder Link Switch Over. The NTN network device may acquire the TNL link supported by the old feeder link as the second TNL link.

In some embodiments of S42, the NTN network device may acquire the handover configuration of the TNL link.

The handover configuration of the TNL link may be pre-configured, or the handover configuration of the TNL link may also be calculated according to pre-configuration. The handover configuration of the TNL link may include at least one of the following: a handover type of the first TNL link, a valid time of the first TNL link (hereinafter referred to as a first valid time), an address of the first TNL link, a valid time of the second TNL link (hereinafter referred to as a second valid time), or an address of the second TNL link.

The handover type of the first TNL link is selected from hard handover and soft handover. The handover type of the first TNL link may be pre-configured. For example, the handover type may be configured for the first TNL link according to the capabilities and/or service requirements of the NTN network device. The NTN network device may acquire the pre-configured handover type of the first TNL link.

The first valid time is configured to indicate an available time of the first TNL link. The first valid time may include one or more of a start moment, a disconnection moment, and a connection period of the first TNL link. Within the first valid time (for example, between the start moment and the disconnection moment, for another example, within the connection period), data transmission may be performed by using the first TNL link. Beyond the first valid time (for example, before reaching the start moment, for another example, after reaching the disconnection moment, for another example, beyond the connection period), the first TNL link is in a disconnected state, such that data transmission cannot be performed by using the first TNL link. The first valid time may be determined according to the movement characteristic of the NTN network device. For example, the NTN network device is a satellite-borne BS. The NTN network device may calculate the first valid time of the first TNL link according to the ephemeris information or a satellite service time.

The second valid time is configured to indicate an available time of the second TNL link. The second valid time may include one or more of a start moment, a disconnection moment, and a connection period of the second TNL link. Within the second valid time (for example, between the start moment and the disconnection moment, for another example, within the connection period), data transmission may be performed by using the second TNL link. Beyond the second valid time (for example, before reaching the start moment, for another example, after reaching the disconnection moment, for another example, beyond the connection period), the second TNL link is in a disconnected state, such that data transmission cannot be performed by using the second TNL link. The second valid time may be determined according to the movement characteristic of the NTN network device. For example, the NTN network device is a satellite-borne BS. The NTN network device may calculate the second valid time of the second TNL link according to the ephemeris information or the satellite service time.

The address of the first TNL link is configured to add and/or remove the first TNL link to and/or from the NG interface. By adding and/or removing the address of the first TNL link to and/or from the NG interface, the first TNL link is added and/or removed to and/or from the NG interface. The address of the first TNL link may include at least one of the following: a TNL address, an address of a TNL AMF, or an address of a TNL gateway. The address of the first TNL link may be pre-configured or pre-acquired. For example, the address of the first TNL link may be sent to the NTN network device in advance by means of OAM configuration or pre-configuration.

The address of the second TNL link is configured to add and/or remove the second TNL link to and/or from the NG interface. By adding and/or removing the address of the second TNL link to and/or from the NG interface, the second TNL link is added and/or removed to and/or from the NG interface. The address of the second TNL link may include at least one of the following: a TNL address, an address of a TNL AMF, or an address of a TNL gateway. The address of the second TNL link may be pre-configured or pre-acquired. For example, the address of the second TNL link may be sent to the NTN network device in advance by means of OAM configuration or pre-configuration.

In some embodiments of S42, the NTN network device may acquire the indication information according to the handover configuration of the TNL link. The indication information is configured to indicate the handover configuration of the TNL link. The indication information may include any information that can indicate the handover configuration. For example, the NTN network device may acquire the handover configuration of the TNL link as the indication information. Therefore, the indication information may include the handover configuration of the TNL link. For another example, the NTN network device may acquire, as the indication information, identification information that can identify the handover configuration of the TNL link. Therefore, the indication information may include the identification information configured to identify the handover configuration of the TNL link.

The indication information may indicate the handover type of the first TNL link. The handover type may be selected from hard handover and soft handover.

As an example, the indication information may indicate that the handover type of the first TNL link is hard handover. For example, the indication information may include the identification information configured to identify the handover type of the first TNL link as hard handover.

As another example, the indication information may indicate that the handover type of the first TNL link is soft handover, or may also indicate the second valid time of the second TNL link. For example, the indication information may include the identification information configured to identify the handover type of the first TNL link as soft handover, as well as the second valid time of the second TNL link. For another example, the indication information may include the identification information configured to identify the handover type of the first TNL link as soft handover, as well as identification information configured to identify the second valid time.

As another example, the indication information may indicate that the handover type of the first TNL link is hard handover, or may also indicate the first valid time of the first TNL link. For example, the indication information may include the identification information configured to identify the handover type of the first TNL link as hard handover, as well as the first valid time of the first TNL link. For another example, the indication information may include the identification information configured to identify the handover type of the first TNL link as hard handover, as well as identification information configured to identify the first valid time.

As another example, the indication information may indicate that the handover type of the first TNL link is soft handover, or may also indicate the first valid time of the first TNL link. For example, the indication information may include the identification information configured to identify the handover type of the first TNL link as soft handover, as well as the first valid time of the first TNL link. For another example, the indication information may include the identification information configured to identify the handover type of the first TNL link as soft handover, as well as identification information configured to identify the first valid time.

As another example, the indication information may indicate the handover type of the first TNL link, the first valid time of the first TNL link, and the address of the first TNL link. For example, the indication information may include the identification information configured to identify the handover type of the first TNL link, the first valid time of the first TNL link, and the address of the first TNL link. For another example, the indication information may include the identification information configured to identify the handover type of the first TNL link, the identification information configured to identify the first valid time, and the identification information configured to identify the address of the first TNL link.

In some embodiments of S42, the indication information may be carried by the RAN configuration update message.

When Feeder Link Switch Over occurs, the NTN network device may send the RAN configuration update message to the core network device, so as to update the configuration of the core network device. The NTN network device may acquire the indication information when Feeder Link Switch Over occurs, and may add the indication information to the RAN configuration update message. Therefore, the indication information may be carried by the RAN configuration update message. The core network device may obtain the indication information by receiving the RAN configuration update message, so as to obtain the handover configuration indicated by the indication information. The core network device may send an acknowledge message of the RAN configuration update message to the NTN network device. The NTN network device may receive the acknowledge message of the RAN configuration update message. Optionally, the RAN configuration update message may include the address of the TNL link. Under the condition that the indication information is carried by the RAN configuration update message, the indication information may not indicate the address of the TNL link. For example, the indication information may indicate that the handover type of the first TNL link is hard handover. For another example, the indication information may indicate that the handover type of the first TNL link is soft handover, or may also indicate the second valid time of the second TNL link. Definitely, under the condition that the indication information is carried by the RAN configuration update message, the indication information may also indicate the address of the TNL link.

Therefore, the NTN network device may indicate the handover configuration of the TNL link by means of updating the configuration. By indicating the handover configuration of the TNL link on the NTN network device side, the core network device can automatically update the TNL link on the NG interface, thereby guaranteeing the connection of the NG interface during mobility management. For example, during Feeder Link Switch Over, the NTN network device may send the RAN configuration update message to the core network device only once, without needing to send the RAN configuration update message to the core network device multiple times, such that the number of signaling interactions between the NTN network device and the core network device may be reduced, and the possibility of generating a signaling storm may be reduced.

Furthermore, since the core network device can automatically update the TNL link on the NG interface according to the handover configuration indicated by the indication information, the situation that the NTN network device has been disconnected from the gateway but does not remove the corresponding TNL link from the NG interface in a timely manner is avoided, thereby avoiding a transmission failure of the downlink data, and ensuring service continuity.

The indication information may be carried by adding a field to the RAN configuration update message. For example, the indication information may be carried by adding a TNL association valid timer field and/or a TNL association usage field to the RAN configuration update message. The TNL association valid timer field is configured to carry the valid time of the TNL link. The TNL association usage field is configured to carry the handover type of the TNL link.

An IE in the RAN configuration update message may be shown in Table 2 below.

TABLE 2

| | | | | | | Criticality |
|---|---|---|---|---|---|---|
| IE/Group | | | IE type and | Semantic | | of |
| name | Exist | Range | reference | description | Criticality | allocation |
| TNL | O | | 9.3.1.75 | | Yes | Ignore |
| Association | | | | | | |
| valid timer | | | | | | |
| TNL | O | | ENUMERATED | | Yes | Ignore |
| Association | | | (soft, hard, . . . ) | | | |
| usage | | | | | | |

In some embodiments of S42, the indication information may be carried by an NG setup request message.

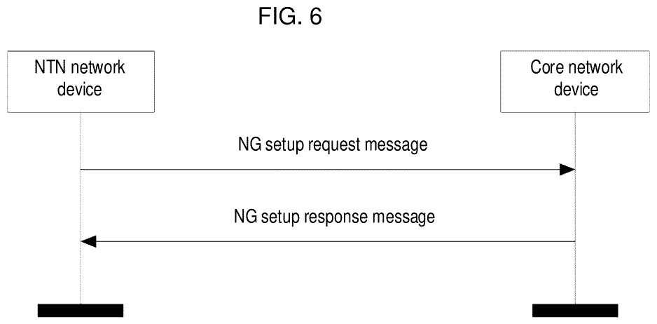

The NG setup request message is configured to establish an NG connection between the NTN network device and the core network device. Referring to FIG. 6, when the NTN network device moves within a service range of the core network device and needs to establish the NG connection with the core network device, the device may send the NG setup request message to the core network device. The NG setup request message includes an NTN network device identifier, a PLMN identifier, a configured tracking area, an access type, default paging DRX, etc. The NTN network device may establish the NG connection with the core network device according to the NG setup request message, and may send an NG setup response message to the NTN network device.

When the NTN network device moves within a service range of the core network device and needs to establish the NG connection with the core network device, the device may acquire the indication information, and may add the indication information to the NG setup request message. Therefore, the indication information may be carried by the NG setup request message. The core network device may establish a connection with the NTN network device according to the NG setup request message. The core network device may acquire the indication information from the NG setup request message, thereby obtaining the handover configuration of the TNL link. The core network device may send the NG setup response message to the NTN network device. The NTN network device may receive the NG setup response message. Optionally, under a condition that the indication information is carried by the NG setup request message, the indication information may indicate the handover type of the first TNL link, the first valid time of the first TNL link, and the address of the first TNL link. The handover type is selected from hard handover and soft handover.

Therefore, the NTN network device may indicate the handover configuration of the TNL link by means of establishing a connection. By indicating the handover configuration of the TNL link on the NTN network device side, the core network device can automatically update the TNL link on the NG interface, thereby guaranteeing the connection of the NG interface during mobility management. For example, the NTN network device does not need to send the RAN configuration update message to the core network device, such that the number of signaling interactions between the NTN network device and the core network device may be reduced.

Furthermore, since the core network device can automatically update the TNL link on the NG interface according to the handover configuration indicated by the indication information, the situation that the NTN network device has been disconnected from the gateway but does not remove the corresponding TNL link from the NG interface in a timely manner is avoided, thereby avoiding a transmission failure of the downlink data, and ensuring service continuity.

The indication information may be carried by adding a field to the NG setup request message. For example, the indication information may be carried by adding a TNL association valid timer field and/or a TNL association usage field to the NG setup request message. The TNL association valid timer field is configured to carry the valid time of the TNL link. The TNL association usage field is configured to carry the handover type of the TNL link.

An IE in the NG setup request message may be shown in Table 3 below.

TABLE 3

| | | | IE type and | Semantic | | Criticality of |
|---|---|---|---|---|---|---|
| IE/Group name | Exist | Range | reference | description | Criticality | allocation |
| NG-RAN TNL | O | | CP Transport Layer | | | |
| Association | | | Information 9.3.2.6 | | | |
| List | | | | | | |
| TNL | O | | 9.3.1.75 | | Yes | Ignore |
| Association | | | | | | |
| valid timer | | | | | | |
| TNL | O | | ENUMERATED | | Yes | Ignore |
| Association | | | (soft, hard, . . . ) | | | |
| usage | | | | | | |

In some embodiments, the core network device may update the available state of the TNL link according to the indication information. For example, the core network device may add and/or remove the TNL link to and/or from the NG interface according to the handover configuration indicated by the indication information, thereby updating the available state of the TNL link. The NG interface is an interface between the NTN network device and the core network device.

The available state of the TNL link includes a connected state and a disconnected state. The TNL link in the connected state may be configured to implement data transmission, and the TNL link in the disconnected state cannot be configured to implement data transmission. The core network device may determine the TNL link in the connected state according to the handover configuration, may add the TNL link in the connected state to the NG interface, may determine the TNL link in the disconnected state according to the handover configuration, and may remove the TNL link in the disconnected state from the NG interface.

The core network device may add the address of the TNL link to the configuration of the NG interface to implement the addition of the TNL link to the NG interface, and may remove the address of the TNL link from the configuration of the NG interface to implement the removal of the TNL link from the NG interface.

As an example, the indication information is configured to indicate that the handover type of the first TNL link is hard handover. The core network device may determine, according to the indication information, that the first TNL link is in the connected state, and determines that the existing second TNL link between the core network device and the NTN network device is in the disconnected state; and may add the first TNL link to the NG interface, and remove the second TNL link. The core network device may add the first TNL link to the NG interface and remove the second TNL link immediately or within a short set time after receiving the indication information. The core network device may first remove the second TNL link from the NG interface and then add the first TNL link to the NG interface. The core network device may also first add the first TNL link to the NG interface and then remove the second TNL link from the NG interface. The adding of the first TNL link and the removal of the second TNL link may be performed at the same time.

As another example, the indication information is configured to indicate that the handover type of the first TNL link is soft handover, and indicate the second valid time of the second TNL link. The core network device may determine, according to the indication information, that the first TNL link is in the connected state, and determines that the existing second TNL link between the core network device and the NTN network device is in the connected state; and may add the first TNL link to the NG interface, and may maintain the second TNL link on the NG interface unchanged. For example, the core network device may add the first TNL link to the NG interface immediately or within a short set time after obtaining the indication information.

Furthermore, the core network device may also determine, according to the indication information, that the second TNL link is in the disconnected state after the second valid time ends, and may remove the second TNL link from the NG interface after the second valid time ends.

As another example, the indication information is configured to indicate that the handover type of the first TNL link is hard handover, and indicate the first valid time of the first TNL link. The core network device may determine, according to the indication information, that the first TNL link is in the connected state after the first valid time is reached, and determines that the existing second TNL link between the core network device and the NTN network device is in the disconnected state after the first valid time is reached; and may add the first TNL link to the NG interface after the first valid time is reached, and remove the existing second TNL link between the core network device and the NTN network device. The core network device may add the first TNL link to the NG interface and remove the second TNL link immediately or within a short set time after the first valid time is reached.

Furthermore, the core network device may also determine, according to the indication information, that the first TNL link is in the disconnected state after the first valid time ends, and may remove the first TNL link from the NG interface after the first valid time ends.

As another example, the indication information is configured to indicate that the handover type of the first TNL link is soft handover, and indicate the first valid time of the first TNL link. The core network device may determine, according to the indication information, that the first TNL link is in the connected state after the first valid time is reached, and determines that the existing second TNL link between the core network device and the NTN network device is in the connected state after the first valid time is reached; and may add the first TNL link to the NG interface after the first valid time is reached, and may maintain the second TNL link on the NG interface unchanged. The core network device may add the first TNL link to the NG interface immediately or within a short set time after the first valid time is reached.

Furthermore, the core network device may also determine, according to the indication information, that the first TNL link is in the disconnected state after the first valid time ends, and may remove the first TNL link from the NG interface after the first valid time ends.

The valid time includes one or more of a start moment, a disconnection moment, and a connection period. Reaching the valid time may refer to reaching the start moment or entering the connection period. The end of the valid time may refer to reaching the disconnection moment or leaving the connection period.

In some embodiments, when the downlink data needs to be sent, the core network device may select a target TNL link according to the available state of the TNL link, and may send the downlink data to the NTN network device by using the target TNL link. The NTN network device may receive the downlink data. Definitely, when the uplink data needs to be sent, the NTN network device may also select the target TNL link, and may send the uplink data to the core network device by using the target TNL link. The core network device may receive the uplink data.

The target TNL link is the TNL link in the connected state. The core network device may select the target TNL link from the TNL links on the NG interface. For soft handover, there may be one or more TNL links on the NG interface. The core network device may select one TNL link from the one or more TNL links as the target TNL link. For hard handover, there is one TNL link on the NG interface. The core network device may select the TNL link as the target TNL link.

The NTN network device may select the target TNL link from the TNL links supported by the connected gateway. The TNL links supported by the gateway may be the TNL links supported by the feeder link corresponding to the gateway. The target TNL link is the TNL link in the connected state. For soft handover, the NTN network device may be connected to one or more gateways, and the one or more gateways support one or more TNL links. The NTN network device may select one TNL link from the one or more TNL links as the target TNL link. For hard handover, the NTN network device may be connected to one gateway, and the gateway supports one TNL link. The NTN network device may select the TNL link as the target TNL link.

As an example, the indication information is configured to indicate that the handover type of the first TNL link is hard handover. The core network device may add the first TNL link to the NG interface and remove the second TNL link according to the indication information.

When the downlink data needs to be sent, the core network device may select the first TNL link as the target TNL link, and may send the downlink data to the NTN network device by using the target TNL link. When the uplink data needs to be sent, the NTN network device may select the first TNL link as the target TNL link, and may send the uplink data to the core network device by using the target TNL link.

As another example, the indication information is configured to indicate that the handover type of the first TNL link is soft handover, and indicate the second valid time of the second TNL link. The core network device may add the first TNL link to the NG interface according to the indication information, and remove the second TNL link from the NG interface after the second valid time ends.

Within the second valid time of the second TNL link, the core network device may select the first TNL link and/or second TNL link as the target TNL link, and may send the downlink data to the NTN network device by using the target TNL link. Within the second valid time of the second TNL link, the NTN network device may select the first TNL link and/or second TNL link as the target TNL link, and may send the uplink data to the core network device by using the target TNL link. After the second valid time of the second TNL link ends, the core network device may select the first TNL link as the target TNL link, and may send the downlink data to the NTN network device by using the target TNL link. After the second valid time of the second TNL link ends, the NTN network device may select the first TNL link as the target TNL link, and may send the uplink data to the core network device by using the target TNL link.

As another example, the indication information is configured to indicate that the handover type of the first TNL link is hard handover, and indicate the first valid time of the first TNL link. The core network device may add the first TNL link to the NG interface and remove the second TNL link according to the indication information after the first valid time is reached, and remove the first TNL link from the NG interface after the first valid time ends.

Within the first valid time of the first TNL link, the core network device may select the first TNL link as the target TNL link, and may send the downlink data to the NTN network device by using the target TNL link; and the NTN network device may select the first TNL link as the target TNL link, and may send the uplink data to the core network device by using the target TNL link.

As another example, the indication information is configured to indicate that the handover type of the first TNL link is soft handover, and indicate the first valid time of the first TNL link. The core network device may add the first TNL link to the NG interface according to the indication information after the first valid time is reached, and remove the first TNL link from the NG interface after the first valid time ends.

Within the first valid time of the first TNL link, the core network device may select the first TNL link and/or second TNL link as the target TNL link, and may send the downlink data to the NTN network device by using the target TNL link; and the NTN network device may select the first TNL link and/or second TNL link as the target TNL link, and may send the uplink data to the core network device by using the target TNL link. The following describes a plurality of scenario examples of the embodiments of the present specification.

### Scenario Example I

In Scenario example I, an NTN network device may indicate handover configuration of a TNL link by means of updating the configuration.

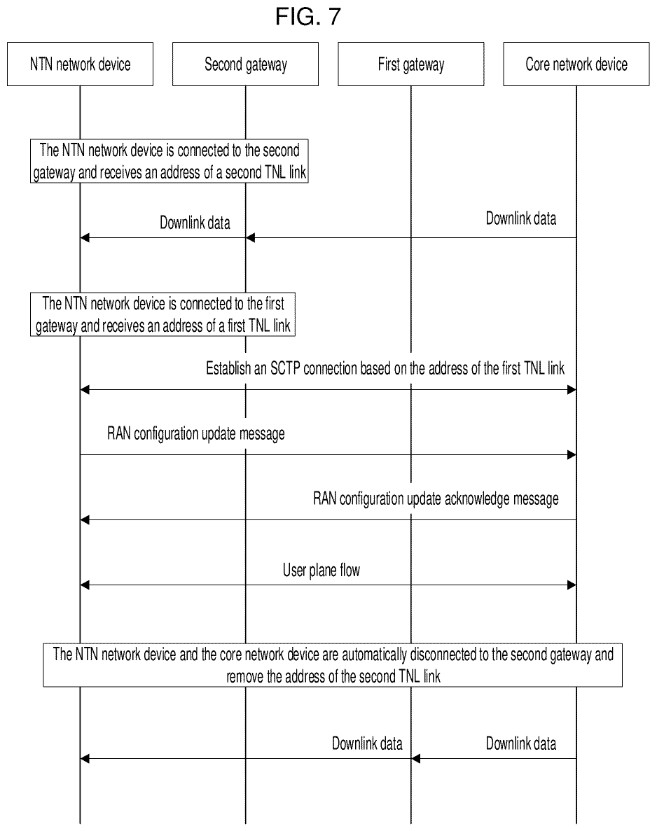

Referring to FIG. 7, Scenario example 1 is a soft handover process.

The NTN network device is connected to a second gateway. A physical link between the NTN network device and the second gateway is a second feeder link. The second feeder link supports a second TNL link. The second gateway is pre-configured with an address of the second TNL link. The NTN network device may acquire the address of the second TNL link via the second gateway, and may establish an SCTP connection based on the address of the second TNL link. A core network device may send downlink data to the NTN network device by using the second TNL link. For example, the core network device may send the downlink data to the second gateway, and the second gateway may receive the downlink data and sends it to the NTN network device. The NTN network device may use the second TNL link to send uplink data to the core network device. For example, the NTN network device may send the uplink data to the second gateway, and the second gateway receives the uplink data and sends it to the core network device.

Due to the movement of the NTN network device, the NTN network device is connected to a first gateway. A physical link between the NTN network device and the first gateway is a first feeder link. The first feeder link supports a first TNL link. The first gateway is pre-configured with an address of the first TNL link. The NTN network device may acquire the address of the first TNL link via the first gateway, and may establish an SCTP connection based on the address of the first TNL link. A pre-configured handover type of the first TNL link is soft handover. In this case, the NTN network device simultaneously maintains the SCTP connection corresponding to the second TNL link and the SCTP connection corresponding to the first TNL link. Based on the second TNL link and the first TNL link, the NTN network device may send the uplink data by using a plurality of different paths.

The NTN network device may determine a second valid time of the second TNL link, and may generate indication information. The indication information is configured to indicate that the handover type of the first TNL link is soft handover, and indicate the second valid time of the second TNL link. The NTN network device may send a RAN configuration update message to the core network device. For example, the NTN network device may send the RAN configuration update message by using the second TNL link or the first TNL link. The core network device may receive the RAN configuration update message, and may send an acknowledge message of the RAN configuration update message to the NTN network device. The indication information may be carried by the RAN configuration update message. The core network device may acquire the indication information from the RAN configuration update message, may add the first TNL link to an NG interface according to the indication information, and maintain the existing second TNL link on the NG interface unchanged. For example, the RAN configuration update message may include the address of the first TNL link. The core network device may add the address of the first TNL link to the NG interface. In this case, the NG interface has the first TNL link and the second TNL link. The core network device considers that the first TNL link and the second TNL link are in a connected state. Based on the second TNL link and the first TNL link, the core network device may send the downlink data by using the plurality of different paths.

The NTN network device and the core network device may perform PDU session modification for a UE of a current serving cell, so as to prepare for user plane data transmission.

After the second valid time of the second TNL link ends, the core network device considers that the NTN network device is disconnected from the second gateway, and the second TNL link is in a disconnected state, such that the second TNL link may be removed from the NG interface. For example, the core network device may remove the address of the second TNL link from the NG interface. In this case, the NG interface is configured with the first TNL link, and is not configured with the second TNL link. The core network device sends the downlink data via the first TNL link. For example, the core network device may send the downlink data to the first gateway. The first gateway may receive the downlink data and sends it to the NTN network device.

In Scenario example I, the NTN network device sends, to the core network device, the RAN configuration update message carrying the indication information, such that the core network device can know that the handover type of the first TNL link is soft handover, as well as the second valid time of the second TNL link. Within the second valid time of the second TNL link, the core network device considers that the first TNL link and the second TNL link are in the connected state, and may send the downlink data via the second TNL link and/or first TNL link. After the end of the second valid time of the second TNL link, the core network device considers that the second TNL link is in the disconnected state, and may send the downlink data via the first TNL link. Therefore, the NTN network device sends the RAN configuration update message to the core network device once, such that the core network device can automatically add the first TNL link to the NG interface and remove the second TNL link, thereby realizing the maintenance of functions of the NG interface between the NTN network device and the core network device. The NTN network device does not need to send the RAN configuration update message configured to add the first TNL link and the RAN configuration update message configured to remove the second TNL link, respectively, such that the number of signaling interactions between the NTN network device and the core network device may be reduced, the possibility of generating a signaling storm may be reduced, and a service transmission delay may also be reduced.

### Scenario Example II

In Scenario example II, an NTN network device may indicate handover configuration of a TNL link by means of updating the configuration.

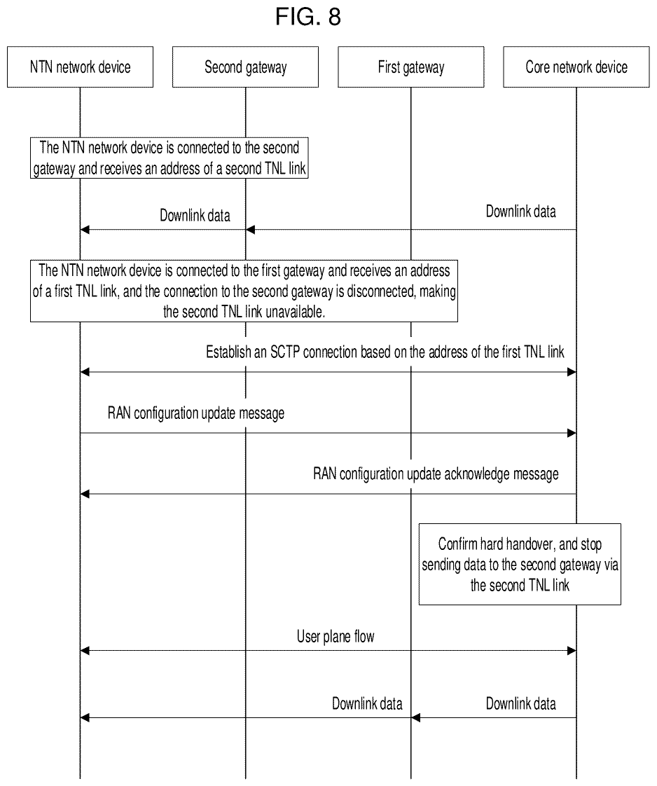

Referring to FIG. 8, Scenario example II is a hard handover process.

The NTN network device is connected to a second gateway. A physical link between the NTN network device and the second gateway is a second feeder link. The second feeder link supports a second TNL link. The second gateway is pre-configured with an address of the second TNL link. The NTN network device may acquire the address of the second TNL link via the second gateway, and may establish an SCTP connection based on the address of the second TNL link. A core network device may send downlink data to the NTN network device by using the second TNL link. For example, the core network device may send the downlink data to the second gateway, and the second gateway may receive the downlink data and sends it to the NTN network device. The NTN network device may use the second TNL link to send uplink data to the core network device. For example, the NTN network device may send the uplink data to the second gateway, and the second gateway receives the uplink data and sends it to the core network device.

Due to the movement of the NTN network device, the NTN network device is connected to a first gateway. A physical link between the NTN network device and the first gateway is a first feeder link. The first feeder link supports a first TNL link. The first gateway is pre-configured with an address of the first TNL link. The NTN network device acquires the address of the first TNL link via the first gateway, and may establish an SCTP connection based on the address of the first TNL link. A pre-configured handover type of the first TNL link is hard handover. The NTN network device may be disconnected from a second gateway. In this case, the NTN network device maintains the SCTP connection corresponding to the first TNL link, and does not maintain the SCTP connection corresponding to the second TNL link. The NTN network device uses the first TNL link to send uplink data.

The NTN network device may generate indication information. The indication information is configured to indicate that the handover type of the first TNL link is hard handover. The NTN network device may send a RAN configuration update message to the core network device. For example, the NTN network device may send the RAN configuration update message by using the first TNL link. The core network device may receive the RAN configuration update message, and may send an acknowledge message of the RAN configuration update message to the NTN network device. The indication information may be carried by the RAN configuration update message. The core network device may acquire the indication information from the RAN configuration update message, may add the first TNL link to the NG interface according to the indication information, and remove the second TNL link. For example, the RAN configuration update message includes the address of the first TNL link. The core network device may add the address of the first TNL link to the NG interface. In this case, the NG interface is configured with the first TNL link, and is not configured with the second TNL link. The core network device sends the downlink data via the first TNL link. For example, the core network device may send the downlink data to the first gateway. The first gateway may receive the downlink data and sends it to the NTN network device.

The NTN network device and the core network device may perform PDU session modification for a UE of a current serving cell, so as to prepare for user plane data transmission.

In Scenario example II, the NTN network device sends, to the core network device, the RAN configuration update message carrying the indication information, such that the core network device can know that the handover type of the first TNL link is hard handover. According to the indication information, the core network device may determine that the first TNL link is in the connected state and the second TNL link is in the disconnected state. Therefore, the NTN network device sends the RAN configuration update message to the core network device once, such that the core network device automatically adds the first TNL link to the NG interface and remove the second TNL link, thereby realizing the maintenance of functions of the NG interface between the NTN network device and the core network device. The NTN network device does not need to send the RAN configuration update message configured to add the first TNL link and the RAN configuration update message configured to remove the second TNL link, respectively, such that the number of signaling interactions between the NTN network device and the core network device may be reduced, the possibility of generating a signaling storm may be reduced, and a service transmission delay may also be reduced.

Furthermore, the core network device removes the second TNL link from the NG interface after receiving the RAN configuration update message carrying the indication information, so as to stop sending data to the second gateway. In this way, a situation that the NTN network device is connected from the second gateway may be avoided, and the core network device sends the downlink data to the second gateway, resulting in a data transmission failure.

### Scenario Example III

In Scenario example III, an NTN network device may indicate handover configuration of a TNL link by means of establishing a connection.

In an NTN, the NTN network device has high dynamicity. The movement characteristic of the NTN network device may be predictable. The connection between the NTN network device and the gateway may be predetermined. The NTN network device knows which gateway or gateways it is connected to. Furthermore, the gateway is connected to the core network device. The core network device knows the gateway it is connected to. Information such as an IP address, a position, etc. of the gateway does not change. The information of the gateway and the information of the core network device may be sent to the NTN network device in advance. For example, the information of the gateway and the information of the core network device may be sent to the NTN network device by means of Operation Administration and Maintenance (OAM) configuration or pre-configuration. The NTN network device may determine the TNL link that may be established in the future as the first TNL link according to one or more of its own movement trajectory, the information of the gateway, and the information of the core network device. The TNL link that may be established in the future may include a TNL link supported by the gateway to which the NTN network device may be connected in the future.

The NTN network device may acquire the handover configuration of each first TNL link, and may acquire indication information according to the handover configuration of each first TNL link. The indication information is configured to indicate the handover configuration of each first TNL link. The handover configuration of the first TNL link may be pre-configured, or the handover configuration of the first TNL link may also be calculated according to pre-configuration. The handover configuration of the first TNL link may include at least one of the following: a handover type of the first TNL link, a first valid time of the first TNL link, or an address of the first TNL link. The indication information may indicate the handover type of each first TNL link, the first valid time of each first TNL link, and the address of each first TNL link.

When the NTN network device moves within a service range of the core network device and needs to establish the NG connection with the core network device, the device may add the indication information to the NG setup request message. Therefore, the indication information may be carried by the NG setup request message, and may send the NG setup request message to the core network device. The core network device establishes a connection with the NTN network device according to the NG setup request message. The core network device sends the NG setup response message to the NTN network device. The NTN network device receives the NG setup response message.

The core network device may acquire the indication information from the NG setup request message, and may update an available state of the TNL link according to the indication information. For example, the core network device may add and/or remove the TNL link to and/or from the NG interface according to the handover configuration indicated by the indication information. The NG interface is an interface between the NTN network device and the core network device. For each first TNL link, after the first valid time of each first TNL link is reached, if the handover type of the first TNL link is hard handover, the core network device may add the first TNL link to the NG interface and remove an existing second TNL link between the core network device and the NTN network device; and if the handover type of the first TNL link is soft handover, the core network device may add the first TNL link to the NG interface and maintain the existing second TNL link between the core network device and the NTN network device unchanged. Furthermore, for each first TNL link, after the first valid time of the first TNL link ends, the core network device may remove the first TNL link from the NG interface.

When the downlink data needs to be sent, the core network device may select a target TNL link from the TNL links configured by the NG interface, and may send the downlink data to the NTN network device by using the target TNL link. The NTN network device may receive the downlink data. For soft handover, there may be one or more TNL links on the NG interface. The core network device may select one TNL link from the one or more TNL links as the target TNL link. For hard handover, there is one TNL link on the NG interface. The core network device may select the TNL link as the target TNL link.

When the uplink data needs to be sent, the NTN network device may select the target TNL link from the TNL links supported by the connected gateway, and may send the uplink data to the core network device by using the target TNL link. The core network device may receive the uplink data. For soft handover, the NTN network device may be connected to one or more gateways, and the one or more gateways support one or more TNL links. The NTN network device may select one TNL link from the one or more TNL links as the target TNL link. For hard handover, the NTN network device may be connected to one gateway, and the gateway supports one TNL link. The NTN network device may select the TNL link as the target TNL link.

In Scenario example III, an NTN network device may indicate handover configuration of a TNL link by means of establishing a connection. By indicating the handover configuration of the TNL link on the NTN network device side, the core network device can automatically update the TNL link on the NG interface, thereby guaranteeing the connection of the NG interface during mobility management. For example, the NTN network device does not need to send the RAN configuration update message to the core network device, such that the number of signaling interactions between the NTN network device and the core network device may be reduced.

Furthermore, since the core network device can automatically update the TNL link of the NG interface according to the indicated handover configuration, the situation that the NTN network device has been disconnected from the gateway but does not remove the corresponding TNL link from the NG interface in a timely manner is avoided, thereby avoiding a transmission failure of the downlink data, and ensuring service continuity.

The above only describes the steps or processes related to the embodiments of the present specification, but the embodiments of the present specification are not limited thereto. The method in the embodiments of the present specification may also include other steps or processes. For details regarding these steps or processes, reference may be made to the relevant techniques. Furthermore, the above embodiments are provided merely as examples of the embodiments described herein. However, the scope of the present specification is not limited thereto, and appropriate modifications may be made based on the above embodiments. For example, the above embodiments may be used individually, or one or more of the above embodiments may be combined.

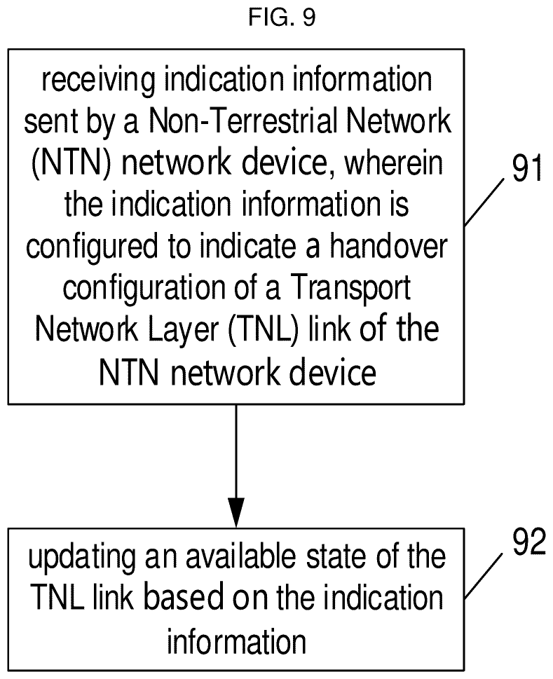

An embodiment of the present specification further provides another mobility management method. The mobility management method may be applied to a core network device. Referring to FIGS. 5 and 9, the mobility management method may include the following steps.

At S91, receiving indication information sent by a Non-Terrestrial Network (NTN) network device, wherein the indication information is configured to indicate a handover configuration of a Transport Network Layer (TNL) link of the NTN network device.

At S92, updating an available state of the TNL link based on the indication information.

The core network device may receive the indication information of an NTN network device. The indication information is configured to indicate the handover configuration of the TNL link. By indicating the handover configuration of the TNL link on the NTN network device side, the available state of the TNL link may be indicated, such that the core network device can automatically update the TNL link on the NG interface, thereby guaranteeing the connection of the NG interface during mobility management. Therefore, the number of signaling interactions of the NG interface (e.g., the NG-C interface) may be reduced, and a service transmission delay may also be reduced. For example, the NTN network device does not need to send the RAN configuration update message configured to add a new TNL link (e.g., the first TNL link) and the RAN configuration update message configured to remove an old TNL link (e.g., the second TNL link), respectively, such that the number of signaling interactions between the NTN network device and the core network device may be reduced, and a service transmission delay may also be reduced.

In some embodiments, the NTN network device may determine the TNL link, may acquire handover configuration of the TNL link, and may acquire the indication information according to the handover configuration of the TNL link. The indication information is configured to indicate the handover configuration of the TNL link.

The NTN network device may determine one or more first TNL links. The first TNL link is a newly added TNL link between the core network device and the NTN network device. The NTN network device may also determine one or more second TNL links. The second TNL link is an existing TNL link between the core network device and the NTN network device.

The handover configuration of the TNL link includes at least one of the following: a handover type of the first TNL link, a first valid time of the first TNL link, an address of the first TNL link, a second valid time of the second TNL link, or an address of the second TNL link.

In some embodiments of S91, the indication information may be carried by a RAN configuration update message. The core network device may receive the RAN configuration update message carrying the indication information, so as to obtain the indication information.

In some embodiments of S91, the indication information may be carried by an NG setup request message. The core network device may receive the NG setup request message carrying the indication information, so as to obtain the indication information.

In some embodiments of S92, the core network device may update an available state of the TNL link according to the indication information. For example, the core network device may add or remove the TNL link to or from the NG interface according to the handover configuration indicated by the indication information, thereby updating the available state of the TNL link. The NG interface is an interface between the NTN network device and the core network device.

As an example, the indication information is configured to indicate that the handover type of the first TNL link is hard handover. The core network device may add the first TNL link to the NG interface and remove the second TNL link according to the indication information.

As another example, the indication information is configured to indicate that the handover type of the first TNL link is soft handover, and indicate the second valid time of the second TNL link. The core network device may add the first TNL link to the NG interface according to the indication information, maintain the second TNL link on the NG interface unchanged, and remove the second TNL link from the NG interface after the second valid time ends.

As another example, the indication information is configured to indicate that the handover type of the first TNL link is hard handover, and indicate the first valid time of the first TNL link. The core network device may, according to the indication information, add the first TNL link to the NG interface and remove the existing second TNL link between the core network device and the NTN network device after the first valid time is reached, and may remove the first TNL link from the NG interface after the first valid time ends.

As another example, the indication information is configured to indicate that the handover type of the first TNL link is soft handover, and indicate the first valid time of the first TNL link. The core network device may add the first TNL link to the NG interface according to the indication information after the first valid time is reached, maintain the existing second TNL link between the core network device and the NTN network device unchanged, and remove the first TNL link from the NG interface after the first valid time ends.

In some embodiments, when the downlink data needs to be sent, the core network device may select a target TNL link according to the available state of the TNL link, and may send the downlink data to the NTN network device by using the target TNL link. The NTN network device may receive the downlink data. Definitely, when the uplink data needs to be sent, the NTN network device may also select the target TNL link, and may send the uplink data to the core network device by using the target TNL link. The core network device may receive the uplink data.

The target TNL link is the TNL link in the connected state. The core network device may select a target TNL link from the TNL links configured for the NG interface. For soft handover, there may be one or more TNL links on the NG interface. The core network device may select one TNL link from the one or more TNL links as the target TNL link. For hard handover, there is one TNL link on the NG interface. The core network device may select the TNL link as the target TNL link.

The above only describes the steps or processes related to the embodiments of the present specification, but the embodiments of the present specification are not limited thereto. The method in the embodiments of the present specification may also include other steps or processes. For details regarding these steps or processes, reference may be made to the relevant techniques. Furthermore, the above embodiments are provided merely as examples of the embodiments described herein. However, the scope of the present specification is not limited thereto, and appropriate modifications may be made based on the above embodiments. For example, the above embodiments may be used individually, or one or more of the above embodiments may be combined.

For portions in the embodiments corresponding to FIG. 9 that are identical to those in the embodiments corresponding to FIG. 4, reference may be made in the description of the embodiments corresponding to FIG. 4, and is not described herein again.

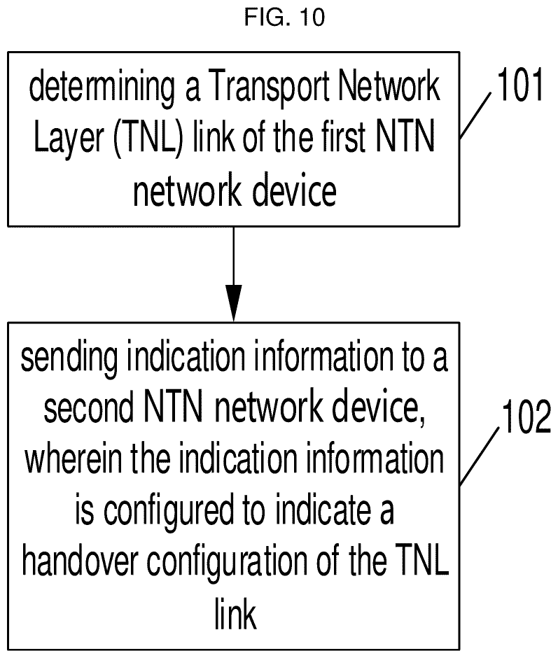

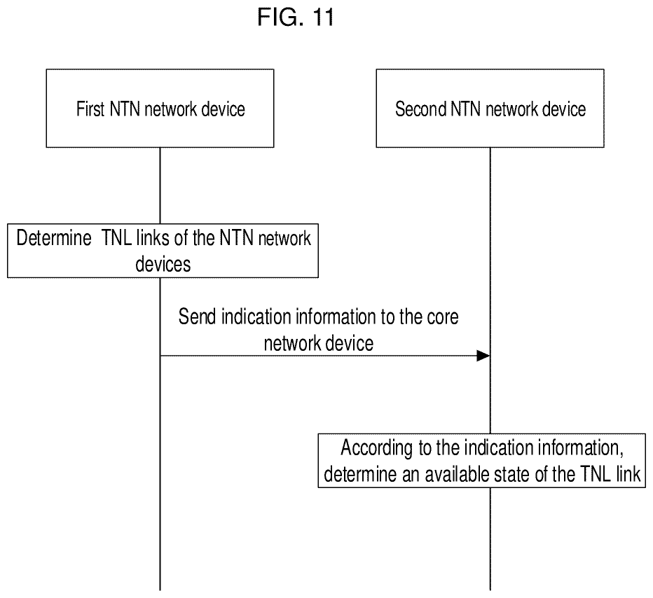

An embodiment of the present specification further provides another mobility management method. The mobility management method may be applied to a first NTN network device. Referring to FIGS. 10 and 11, the mobility management method may include the following steps.

At S101, determining a Transport Network Layer (TNL) link of the first NTN network device.

At S102, sending indication information to a second NTN network device, wherein the indication information is configured to indicate a handover configuration of the TNL link.

The first NTN network device may determine its own TNL link, and may send the indication information to a second NTN network device. The indication information is configured to indicate the handover configuration of the TNL link. By indicating the handover configuration of the TNL link, an available state of the TNL link may be indicated. Therefore, the second NTN network device can know the available state of the TNL link between the first NTN network device and the core network device, such that the second NTN network device may automatically select a path for data transmission with the core network device, thereby guaranteeing the connection of the NG interface of the second NTN network device during mobility management. Therefore, the number of signaling interactions of the NG interface corresponding to the second NTN network device may be reduced, and a service transmission delay may be reduced. For example, the second NTN network device does not need to send the RAN configuration update message configured to add a new TNL link and the RAN configuration update message configured to remove an old TNL link, respectively, such that the number of signaling interactions between the second NTN network device and the core network device may be reduced.

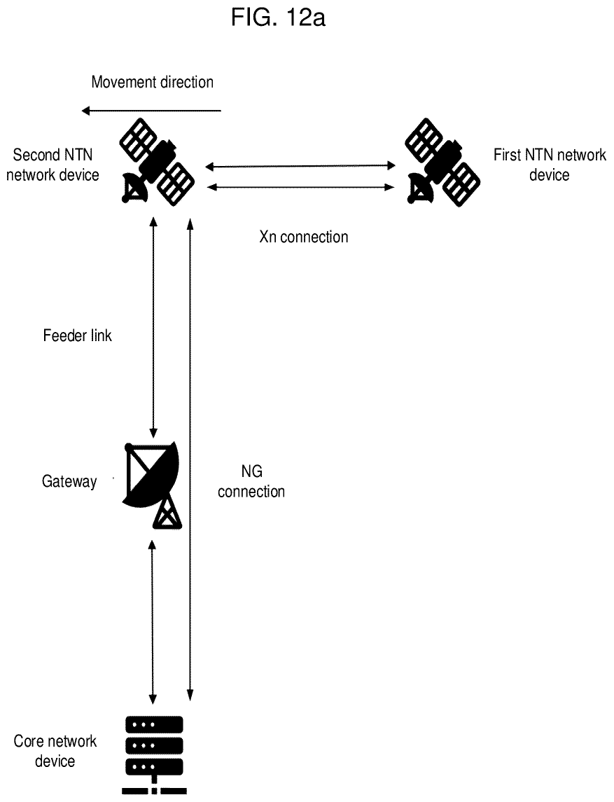

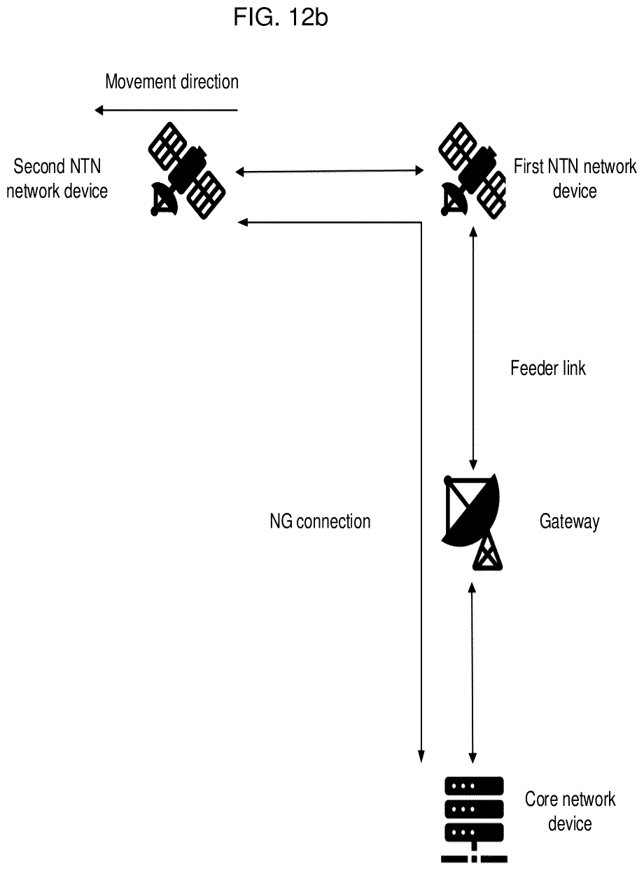

In some embodiments, the first NTN network device and the second NTN network device may communicate with each other. The second NTN network device and the core network device may communicate with each other. Therefore, the second NTN network device and the core network device may communicate with each other via the first NTN network device. Referring to FIG. 12a, the first NTN network device and the second NTN network device may communicate with each other via an Xn interface. The second NTN network device and the core network device may communicate with each other via the NG interface. Referring to FIG. 12b, during the movement of the second NTN network device, when the second NTN network device is disconnected from the core network device, but the first NTN network device is connected to the gateway, the second NTN network device may maintain a connection of the NG interfaces between the second NTN network device and the core network device through the connection with the first NTN network device and the connection between the first NTN network device and the gateway, thereby causing the NG interface of an RNL to be not disconnected.

The second NTN network device may send uplink data to the core network device via the first NTN network device. For example, the second NTN network device may send the uplink data to the first NTN network device, and the first NTN network device may receive the uplink data and send it to the core network device. The core network device may send downlink data to the second NTN network device via the first NTN network device. For example, the core network device may send the downlink data to the first NTN network device, and the first NTN network device may receive the downlink data and send it to the second NTN network device. Therefore, the first NTN network device can forward data between the second NTN network device and the core network device, thereby implementing data transmission between the second NTN network device and the core network device.

In some embodiments of S101, the first NTN network device may determine the TNL link when required to send an Xn message to the second NTN network device. Alternatively, the first NTN network device may predetermine the TNL link before sending the Xn message to the second NTN network device. The Xn message includes a message of the Xn interface.

For example, the Xn message includes an Xn setup message. The Xn setup message is configured to establish a connection between the NTN network devices. The first NTN network device may determine the TNL link when required to establish a connection with the second NTN network device. Alternatively, the first NTN network device may predetermine the TNL link before establishing the connection with the second NTN network device. The indication information is carried by the Xn setup message. Therefore, the first NTN network device indicates the handover configuration of the TNL link by means of establishing a connection.

For another example, the Xn message includes a non-Xn setup message, such as an RAN paging message. The first NTN network device may determine the TNL link when required to send the non-Xn setup message. The indication information may be carried by the non-Xn setup message. Therefore, the first NTN network device may indicate the handover configuration of the TNL link via the non-Xn setup message.

In some embodiments of S101, the first NTN network device may determine one or more first TNL links. The first TNL link is a newly added TNL link between the core network device and the first NTN network device. The first TNL link may be a TNL link that has not established a communication connection, or may also be a TNL link that has established the communication connection but not been configured to implement data transmission.

The first NTN network device has high dynamicity. The movement characteristic of the first NTN network device may be predictable. The connection between the first NTN network device and the gateway may be predetermined. The first NTN network device knows which gateway or gateways it is connected to. Furthermore, the gateway is connected to the core network device. The core network device knows the gateway it is connected to. Information such as an IP address, a position, etc. of the gateway does not change. The information of the gateway and the information of the core network device may be sent to the first NTN network device in advance. For example, the information of the gateway and the information of the core network device may be sent to the first NTN network device by means of OAM configuration or pre-configuration. The first NTN network device may determine the TNL link that may be established in the future as the first TNL link according to one or more of its own movement trajectory, the information of the gateway, and the information of the core network device. The TNL link that may be established in the future may include a TNL link supported by the gateway to which the first NTN network device may be connected in the future. For example, the first NTN network device may include the satellite-borne BS. The satellite-borne BS determines the TNL link that may be established in the future as the first TNL link according to one or more of its own movement trajectory, ephemeris information, the information of the gateway, and the information of the core network device.

In some embodiments of S102, the first NTN network device may acquire the handover configuration of the TNL link, and may acquire the indication information according to the handover configuration of the TNL link. The indication information is configured to indicate the handover configuration of the TNL link.

The handover configuration of the TNL link may be pre-configured, or the handover configuration of the TNL link may also be calculated according to pre-configuration. The handover configuration of the TNL link may include at least one of the following: a handover type of the first TNL link, a first valid time of the first TNL link, an address of the first TNL link, or functional identification information of the first NTN network device. The functional identification information of the first NTN network device is configured to indicate whether the first NTN network device supports NG transmission of a multi-NTN network device communication. For example, the functional identification information of the first NTN network device is configured to indicate that the first NTN network device supports the NG transmission of the multi-NTN network device communication. The functional identification information may be pre-configured.

The indication information may include any information that can indicate the handover configuration. The indication information may include the handover configuration of the TNL link. Alternatively, the indication information may include the identification information configured to identify the handover configuration of the TNL link.

The indication information may indicate the handover type of the first TNL link. As an example, the indication information may indicate that the handover type of the first TNL link is hard handover, or may also indicate the first valid time of the first TNL link. As another example, the indication information may indicate that the handover type of the first TNL link is soft handover, or may also indicate the first valid time of the first TNL link. As another example, the indication information may indicate the handover type of the first TNL link, the first valid time of the first TNL link, the address of the first TNL link, and the functional identification information of the first NTN network device.

In some embodiments of S102, the indication information may be carried by the Xn message. The Xn message may include the message of the Xn interface. The Xn message may include the Xn setup message. The Xn setup message is configured to establish a connection between the NTN network devices. The Xn message may further include the non-Xn setup message, such as the RAN paging message. The first NTN network device may acquire the indication information when required to send the Xn message to the second NTN network device, and may add the indication information to the Xn message. Therefore, the indication information may be carried by the Xn message. The second NTN network device may receive the Xn message, and may acquire the indication information from the Xn message, thereby obtaining the handover configuration of the TNL link. The second NTN network device may send a response message of the Xn message to the first NTN network device. The first NTN network device may receive the response message of the Xn message.

For example, the first NTN network device may acquire the indication information when required to establish a connection with the second NTN network device, and may add the indication information to the Xn setup message. Therefore, the indication information may be carried by the Xn setup message. The second NTN network device may establish a connection with the first NTN network device according to the Xn setup message. The second NTN network device may acquire the indication information from the Xn setup message. The second NTN network device may send the response message of the Xn setup message to the first NTN network device. Therefore, the first NTN network device may indicate the handover configuration of the TNL link by means of establishing a connection.

For another example, the first NTN network device may acquire the indication information when required to send the Xn setup message, and may add the indication information to the Xn setup message. Therefore, the indication information may be carried by the non-Xn setup message. The second NTN network device may receive the non-Xn setup message, and may acquire the indication information from the non-Xn setup message. The second NTN network device may send the response message of the non-Xn setup message to the first NTN network device. The first NTN network device may receive the response message of the non-Xn setup message. Therefore, the first NTN network device may indicate the handover configuration of the TNL link via the non-Xn setup message.

The indication information may be carried by adding a field to the Xn message. For example, the indication information may be carried by adding a TNL association valid timer field and/or a TNL association usage field to the Xn message. The TNL association valid timer field is configured to carry the valid time of the TNL link. The TNL association usage field is configured to carry the handover type of the TNL link.

In some embodiments, the second NTN network device may determine the available state of the TNL link of the first NTN network device side according to the indication information. When the uplink data needs to be sent, the second NTN network device may select a target TNL link according to the available state of the TNL link of the first NTN network device side, and may send the uplink data to the core network device by using the target TNL link via the first NTN network device. The core network device may receive the uplink data. For example, the second NTN network device may send uplink data to the first NTN network device. The first NTN network device may receive and use the target TNL link to send uplink data to the core network device. For example, the second NTN network device may send uplink data to the first NTN network device and link identification information configured to identify the target TNL link. The first NTN network device may send the uplink data to the core network device by using the target TNL link corresponding to the link identification information. For example, the first NTN network device may send the uplink data to a gateway corresponding to the target TNL link, and the gateway may receive the uplink data and send it to the core network device. The link identification information includes any information that can identify the TNL link. For example, the link identification information may be a name, a number, or the like of the TNL link.

The available state of the TNL link may include a connected state and a disconnected state. The TNL link in the connected state may be configured to implement data transmission, and the TNL link in the disconnected state cannot be configured to implement data transmission. The second NTN network device may determine the TNL link in the connected state and the TNL link in the disconnected state according to the handover configuration indicated by the indication information. When the uplink data needs to be sent, the second NTN network device may select the target TNL link from the TNL links in the connected state.

For soft handover, there is one or more TNL links in the connected state. The second NTN network device may select the target TNL link from the one or more TNL links. For hard handover, there is one TNL link in the connected state. The second NTN network device may select the TNL link as the target TNL link.

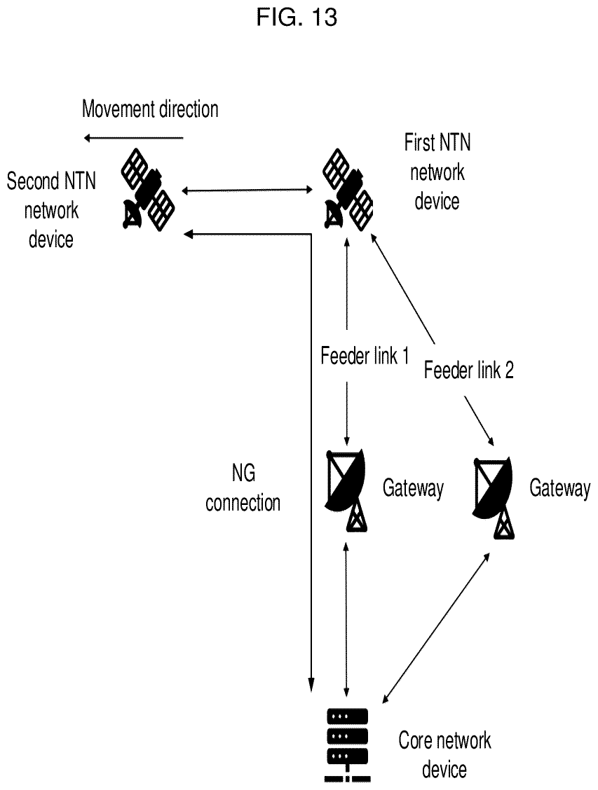

For each first TNL link, in a case where the handover type of the first TNL link is hard handover, the second NTN network device may determine that the first TNL link is in the connected state within the first valid time of the first TNL link and the existing second TNL link between the first NTN network device and the core network device is in the disconnected state, and may select the first TNL link as the target TNL link. Referring to FIG. 13, for each first TNL link, in a case where the handover type of the first TNL link is soft handover, the second NTN network device may determine that the first TNL link is in the connected state within the first valid time of the first TNL link and the existing second TNL link between the first NTN network device and the core network device is also in the connected state, and may select the first TNL link and/or second TNL link as the target TNL link.

In some embodiments, the first NTN network device may also send the indication information to the core network device. The indication information may be carried by the NG setup request message or the RAN configuration update message. The core network device may update the available state of the TNL link according to the indication information. For example, the core network device may add or remove the TNL link to or from the NG interface according to the handover configuration indicated by the indication information, thereby updating the available state of the TNL link. The NG interface is an interface between the NTN network device and the core network device. When the downlink data needs to be sent, the core network device may select a target TNL link according to the available state of the TNL link, and may send the downlink data to the second NTN network device by using the target TNL link. For example, the core network device may send the downlink data to the first NTN network device by using the target TNL link, and the first NTN network device may receive the downlink data and send it to the second NTN network device. The second NTN network device may receive the downlink data.

The target TNL link is the TNL link in the connected state. The core network device may select the target TNL link from the TNL links on the NG interface. For soft handover, there may be one or more TNL links on the NG interface. The core network device may select one TNL link from the one or more TNL links as the target TNL link. For hard handover, there is one TNL link on the NG interface. The core network device may select the TNL link as the target TNL link.

The above only describes the steps or processes related to the embodiments of the present specification, but the embodiments of the present specification are not limited thereto. The method in the embodiments of the present specification may also include other steps or processes. For details regarding these steps or processes, reference may be made to the relevant techniques. Furthermore, the above embodiments are provided merely as examples of the embodiments described herein. However, the scope of the present specification is not limited thereto, and appropriate modifications may be made based on the above embodiments. For example, the above embodiments may be used individually, or one or more of the above embodiments may be combined.

For portions in the embodiments corresponding to FIG. 10 that are identical to those in the embodiments corresponding to FIG. 4, reference may be made in the description of the embodiments corresponding to FIG. 4, and is not described herein again.

An embodiment of the present specification further provides another mobility management method. The mobility management method may be applied to a second NTN network device. Referring to FIGS. 11 and 14, the mobility management method may include the following steps.

At S141, receiving indication information sent by a first NTN network device, wherein the indication information is configured to indicate a handover configuration of a Transport Network Layer (TNL) link.

At S142, determining an available state of the TNL link based on the indication information.

The second NTN network device may receive the indication information of the first NTN network device. The indication information is configured to indicate the handover configuration of the TNL link. Through the indication information, the second NTN network device may determine the available state of the TNL link on the first NTN network device side, such that the second NTN network device may automatically select a path for data transmission with the core network device, thereby guaranteeing the connection of the NG interface of the second NTN network device during mobility management. Therefore, the number of signaling interactions of the NG interface corresponding to the second NTN network device may be reduced, and a service transmission delay may also be reduced. For example, the second NTN network device does not need to send the RAN configuration update message configured to add a new TNL link and the RAN configuration update message configured to remove an old TNL link, respectively, such that the number of signaling interactions between the second NTN network device and the core network device may be reduced.

In some embodiments, the first NTN network device may determine the TNL link, may acquire handover configuration of the TNL link, and may acquire the indication information according to the handover configuration of the TNL link. The indication information is configured to indicate the handover configuration of the TNL link.

The first NTN network device may determine one or more first TNL links. The first TNL link is a newly added TNL link between the core network device and the first NTN network device. The handover configuration of the TNL link includes at least one of the following: a handover type of the first TNL link, a first valid time of the first TNL link, an address of the first TNL link, or functional identification information of the first NTN network device. The functional identification information of the first NTN network device is configured to indicate whether the first NTN network device supports NG transmission of a multi-NTN network device communication. For example, the functional identification information of the first NTN network device is configured to indicate that the first NTN network device supports the NG transmission of the multi-NTN network device communication. The functional identification information may be pre-configured.

The indication information may include any information that can indicate the handover configuration. For example, the indication information may include handover configuration. For another example, the indication information may include identification information configured to identify the handover configuration. The identification information may be pre-configured. Alternatively, the identification information may also be determined through negotiation between the NTN network device and the core network device.

In some embodiments, the indication information may be carried by an Xn message. The Xn message may include the message of the Xn interface. The Xn message may include the Xn setup message. The Xn setup message is configured to establish a connection between the NTN network devices. The Xn message may further include the non-Xn setup message, such as the RAN paging message.

In some embodiments, the second NTN network device may determine the available state of the TNL link of the first NTN network device side according to the indication information. When the uplink data needs to be sent, the second NTN network device may select a target TNL link according to the available state of the TNL link, and may send the uplink data to the core network device by using the target TNL link via the first NTN network device. The core network device may receive the uplink data. For example, the second NTN network device may send uplink data to the first NTN network device. The first NTN network device may receive and use the target TNL link to send uplink data to the core network device. For example, the second NTN network device may send uplink data to the first NTN network device and link identification information configured to identify the target TNL link. The first NTN network device may send the uplink data to the core network device by using the target TNL link corresponding to the link identification information. For example, the first NTN network device may send the uplink data to a gateway corresponding to the target TNL link, and the gateway may receive the uplink data and send same to the core network device. The link identification information includes any information that can identify the TNL link. For example, the link identification information may be a name, a number, or the like of the TNL link.

The above only describes the steps or processes related to the embodiments of the present specification, but the embodiments of the present specification are not limited thereto. The method in the embodiments of the present specification may also include other steps or processes. For details regarding these steps or processes, reference may be made to the relevant techniques. Furthermore, the above embodiments are provided merely as examples of the embodiments described herein. However, the scope of the present specification is not limited thereto, and appropriate modifications may be made based on the above embodiments. For example, the above embodiments may be used individually, or one or more of the above embodiments may be combined.

For portions in the embodiments corresponding to FIG. 14 that are identical to those in the embodiments corresponding to FIG. 4, reference may be made in the description of the embodiments corresponding to FIG. 4, and is not described herein again.

An embodiment of the present specification further provides a mobility management apparatus. The mobility management apparatus may, for example, be an NTN network device, or may also be a component disposed in the NTN network device. The content same as the embodiments corresponding to FIG. 4 is not described again.

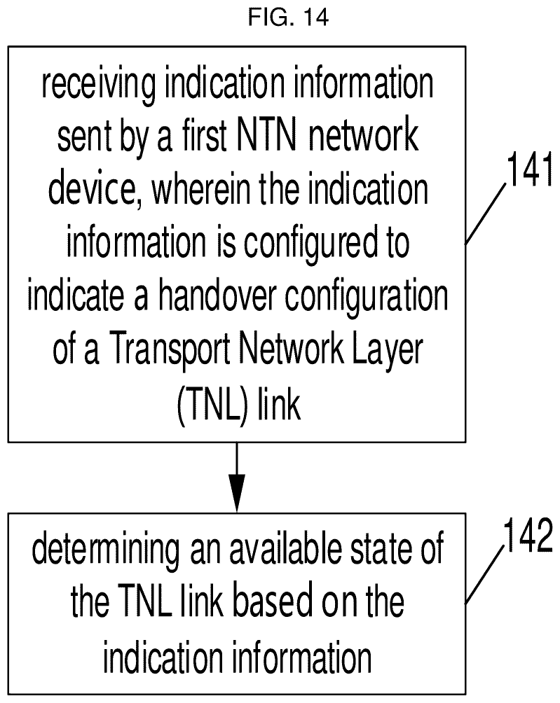

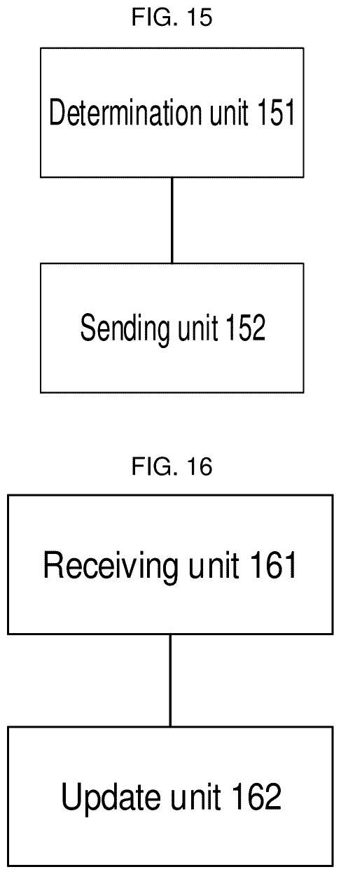

Referring to FIG. 15, the mobility management apparatus may include the following units.

A determination unit 151 is configured to determine a TNL link of the NTN network device.

A sending unit 152 is configured to send indication information to a core network device, wherein the indication information is configured to indicate a handover configuration of the TNL link.

An embodiment of the present specification further provides another mobility management apparatus. The mobility management apparatus may, for example, be a core network device, or may also be a component disposed in the core network device. The content same as the embodiments corresponding to FIG. 9 is not described again.

Referring to FIG. 16, the mobility management apparatus may include the following units.

A receiving unit 161 is configured to receive indication information sent by a Non-Terrestrial Network (NTN) network device, wherein the indication information is configured to indicate a handover configuration of a Transport Network Layer (TNL) link of the NTN network device.

An update unit 162 is configured to update an available state of the TNL link based on the indication information.

An embodiment of the present specification further provides another mobility management apparatus. The mobility management apparatus may, for example, be a first NTN network device, or may also be a component disposed in the first NTN network device. The content same as the embodiments corresponding to FIG. 10 is not described again.

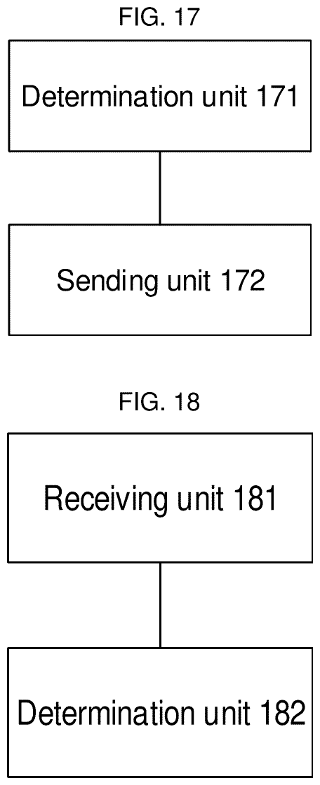

Referring to FIG. 17, the mobility management apparatus may include the following units.

A determination unit 171 is configured to determine a Transport Network Layer (TNL) link of the first NTN network device.

A sending unit 172 is configured to send indication information to a second NTN network device, wherein the indication information is configured to indicate a handover configuration of the TNL link.

An embodiment of the present specification further provides another mobility management apparatus. The mobility management apparatus may, for example, be a second NTN network device, or may also be a component disposed in the second NTN network device. The content same as the embodiments corresponding to FIG. 14 is not described again.

Referring to FIG. 18, the mobility management apparatus may include the following units.

A receiving unit 181 is configured to receive indication information sent by a first NTN network device, wherein the indication information is configured to indicate a handover configuration of a Transport Network Layer (TNL) link.

A determination unit 182 is configured to determine an available state of the TNL link based on the indication information.

An embodiment of the present specification further provides a communication system. The communication system may include an NTN network device and a core network device.

The NTN network device may include a processor and a memory. The memory is configured to store a computer program executable on the processor. The processor, when executing the computer program, implements the method in the embodiments corresponding to FIG. 4.

The core network device may include a processor and a memory. The memory is configured to store a computer program executable on the processor. The processor, when executing the computer program, implements the method in the embodiments corresponding to FIG. 9.

An embodiment of the present specification further provides another communication system. The communication system may include a first NTN network device and a second NTN network device.

The first NTN network device may include a processor and a memory. The memory is configured to store a computer program executable on the processor. The processor, when executing the computer program, implements the method in the embodiments corresponding to FIG. 10.

The second NTN network device may include a processor and a memory. The memory is configured to store a computer program executable on the processor. The processor, when executing the computer program, implements the method in the embodiments corresponding to FIG. 14.

Furthermore, the communication system may further include other devices, such as a core network device.

An embodiment of the present specification further provides an NTN network device, including a memory, a processor, and a computer program that is stored in the memory and executable on the processor. The processor, when executing the computer program, implements the method in the embodiments corresponding to FIG. 4, 10, or 14.

An embodiment of the present specification further provides a core network device, including a memory, a processor, and a computer program that is stored in the memory and executable on the processor. The processor, when executing the computer program, implements the method in the embodiments corresponding to FIG. 9.

An embodiment of the present specification further provides a computer-readable storage medium. The computer-readable storage medium stores a computer program. The computer program, when executed by a processor, implements the above mobility management method.

An embodiment of the present specification further provides a computer program product. The computer program product includes a computer program. The computer program, when executed by a processor, implements the above mobility management method.

Those skilled in the art can understand that the present specification may be provided as a method, a system, or a computer program product. Therefore, the present specification may adopt forms of complete hardware embodiments, complete software embodiments or embodiments integrating software and hardware. Moreover, the present specification may adopt the form of a computer program product implemented on one or more computer available storage media (including but being not limited to a disk memory, a Compact Disc Read Only Memory (CD-ROM), an optical memory, and the like) containing computer available program codes.

The present specification is described with reference to flowcharts and/or block diagrams of the method, device (system), and computer program product according to embodiments of the present specification. It should be understood that each flow and/or block in the flowchart and/or block diagram, and the combination of the flow and/or block in the flowchart and/or block diagram can be implemented by the computer program instructions. The computer may be a personal computer, a laptop computer, a cellular phone, a camera phone, a smartphone, a personal digital assistant, a media player, a navigation device, an email device, a game console, a tablet computer, a wearable device, or a combination of any of these devices.

The functional units in the embodiments of the present specification may be integrated into one processing unit, or may exist as separate physical units, or may be integrated into one processing unit including two or more functional units.

Those skilled in the art can understand that the description of each embodiment in the present specification focuses on specific aspects. For details not elaborated in a particular embodiment, reference may be made to the relevant descriptions in other embodiments. In addition, it may be understood that those skilled in the art, upon reading the present specification, may conceive of arbitrarily combining some or all of the embodiments described herein without requiring creative effort. These combinations also fall within the scope of disclosure and protection of the present specification.

Although the present specification has been described with reference to the embodiments, those skilled in the art should recognize that the above embodiments are merely intended to aid in understanding the core concepts of the present specification. Those skilled in the art can understand that there are numerous modifications and variations to the present specification. It is intended that the appended claims include these modifications and variations without departing from the spirit of the present specification.

1. A mobility management method, applied to a Non-Terrestrial Network (NTN) network device, comprising:
determining a Transport Network Layer (TNL) link of the NTN network device; and
sending indication information to a core network device, wherein the indication information is configured to indicate a handover configuration of the TNL link.

2. The method according to claim 1, wherein the TNL link comprises a first TNL link, and the first TNL link is a TNL link to be newly added between the NTN network device and the core network device; and
wherein the indication information is configured to indicate a handover type of the first TNL link.

3. The method according to claim 2,
wherein the TNL link further comprises a second TNL link, and the second TNL link is an existing TNL link between the NTN network device and the core network device; wherein the indication information is configured to indicate that the handover type of the first TNL link is hard handover; and wherein the hard handover comprises: adding the first TNL link to a Next Generation (NG) interface between the NTN network device and the core network device, and removing the existing second TNL link from the NG interface between the NTN network device and the core network device;
and/or,
wherein the TNL link further comprises a second TNL link, and the second TNL link is an existing TNL link between the NTN network device and the core network device; wherein the indication information is configured to indicate that the handover type of the first TNL link is soft handover; wherein the indication information is further configured to indicate a valid time of the second TNL link; and wherein the soft handover comprises: adding the first TNL link to a Next Generation (NG) interface between the NTN network device and the core network device, and after the valid time is reached, removing the existing second TNL link from the NG interface between the NTN network device and the core network device.

4. The method according to claim 3, wherein the indication information is carried in a Radio Access Network (RAN) configuration update message.

5. The method according to claim 2,
wherein the indication information is configured to indicate that the handover type of the first TNL link is hard handover, and the indication information is further configured to indicate a valid time of the first TNL link; and wherein the hard handover comprises: after the valid time is reached, adding the first TNL link to a Next Generation (NG) interface between the NTN network device and the core network device, and removing the existing second TNL link from the NG interface between the NTN network device and the core network device;
and/or,
wherein the indication information is configured to indicate that the handover type of the first TNL link is soft handover, and the indication information is further configured to indicate a valid time of the first TNL link; and wherein the soft handover comprises: after the valid time is reached, adding the first TNL link to a Next Generation (NG) interface between the NTN network device and the core network device;
and/or,
wherein the indication information is further configured to indicate an address of the first TNL link;
and/or,
wherein the indication information is carried in a Next Generation (NG) setup request message.

6. A mobility management method, applied to a core network device, comprising:
receiving indication information sent by a Non-Terrestrial Network (NTN) network device, wherein the indication information is configured to indicate a handover configuration of a Transport Network Layer (TNL) link of the NTN network device; and
updating an available state of the TNL link based on the indication information.

7. The method according to claim 6, wherein the TNL link comprises a first TNL link, and the first TNL link is a TNL link to be newly added between the NTN network device and the core network device; and
wherein the indication information is configured to indicate a handover type of the first TNL link.

8. The method according to claim 7, wherein in a case where the indication information is configured to indicate that the handover type of the first TNL link is hard handover; updating the available state of the TNL link based on the indication information comprises: adding the first TNL link to a Next Generation (NG) interface between the NTN network device and the core network device, and removing a second TNL link from the NG interface between the NTN network device and the core network device; wherein the second TNL link is an existing TNL link between the NTN network device and the core network device;
and/or,
wherein in a case where the indication information is configured to indicate that the handover type of the first TNL link is soft handover, the indication information is further configured to indicate a valid time of a second TNL link, and the second TNL link is an existing TNL link between the NTN network device and the core network device; updating the available state of the TNL link based on the indication information comprises: adding, by the core network device, the first TNL link to a Next Generation (NG) interface between the NTN network device and the core network device; and after the valid time of the second TNL link is reached, removing, by the core network device, the second TNL link from the NG interface between the NTN network device and the core network device.

9. The method according to claim 8, wherein the indication information is carried in a RAN configuration update message.

10. The method according to claim 7, wherein in a case where the indication information is configured to indicate that the handover type of the first TNL link is hard handover, and the indication information is further configured to indicate a valid time of the first TNL link; updating the available state of the TNL link based on the indication information comprises: after the valid time is reached, adding, by the core network device, the first TNL link to a Next Generation (NG) interface and removing a existing second TNL link from the NG interface between the NTN network device and the core network device;
and/or,
wherein in a case where the indication information is configured to indicate that the handover type of the first TNL link is soft handover, and the indication information is further configured to indicate a valid time of the first TNL link; updating the available state of the TNL link based on the indication information comprises: after the valid time is reached, adding, by the core network device, the first TNL link to a Next Generation (NG) interface between the NTN network device and the core network device;
and/or,
wherein the indication information is further configured to indicate an address of the first TNL link;
and/or,
wherein the indication information is carried in an NG setup request message.

11. The method according to claim 6, the method further comprising:
selecting a target TNL link from one or more TNL links of a NG interface between the NTN network device and the core network device; and
sending downlink data to the NTN network device via the target TNL link.

12. A mobility management method, applied to a first NTN network device and comprising:
determining a Transport Network Layer (TNL) link of the first NTN network device; and
sending indication information to a second NTN network device, wherein the indication information is configured to indicate a handover configuration of the TNL link.

13. The method according to claim 12,
wherein a transmission direction of uplink data is from the second NTN network device to a core network device via the first NTN network device; and a transmission direction of downlink data is from the core network device to the second NTN network device via the first NTN network device;
and/or,
wherein the TNL link comprises a first TNL link, and the first TNL link is a TNL link to be newly added between the first NTN network device and the core network device; and wherein the indication information is configured to indicate a handover type of the first TNL link.

14. The method according to claim 13, wherein the indication information is further configured to indicate at least one of a valid time or an address of the first TNL link.

15. The method according to claim 12,
wherein the indication information is carried in an Xn message, and the Xn message is an Xn setup message or a RAN paging message;
and/or,
wherein the method further comprising: sending the indication information to the core network device.

16. The method according to claim 15, wherein the indication information is carried in a RAN configuration update message or an NG setup request message.

17. A mobility management method, applied to a second NTN network device and comprising:
receiving indication information sent by a first NTN network device, wherein the indication information is configured to indicate a handover configuration of a Transport Network Layer (TNL) link of the NTN network device; and
determining an available state of the TNL link based on the indication information.

18. The method according to claim 17,
wherein a transmission direction of uplink data is from the second NTN network device to a core network device via the first NTN network device; and a transmission direction of downlink data is from the core network device to the second NTN network device via the first NTN network device;
and/or,
wherein the TNL link comprises a first TNL link, and the first TNL link is a TNL link to be newly added between the first NTN network device and the core network device; and wherein the indication information is configured to indicate a handover type of the first TNL link.

19. A NTN network device, comprising a processor and a memory, wherein the memory is configured to store a computer program executable on the processor, and the processor, when executing the computer program, implements instructions of the method according to claim 1.

20. A core network device, comprising a processor and a memory, wherein the memory is configured to store a computer program executable on the processor, and the processor, when executing the computer program, implements instructions of the method claim 6.
